(19) United States
(12) Patent Application Publication
(10) Pub. No.: US 2021/0013974 A1
(43) Pub. Date: Jan. 14, 2021

(54) MIMO WIDEBAND RECEIVER AND TRANSMITTER, AND METHOD THEREOF

(71) Applicant: Industrial Technology Research Institute, Hsinchu (TW)

(72) Inventors: Juinn-Horng Deng, Taoyuan City (TW); Pin-Nien Chen, Changhua County (TW)

(73) Assignee: Industrial Technology Research Institute, Hsinchu (TW)

(21) Appl. No.: 16/731,082

(22) Filed: Dec. 31, 2019

Related U.S. Application Data
(60) Provisional application No. 62/872,251, filed on Jul. 10, 2019.

(51) Int. Cl. H04B 15/00; H04B 7/0456; H04B 17/00; H04B 10/556

(52) U.S. Cl. CPC H04B 15/005; H04B 10/5561; H04B 17/0085; H04B 7/0456

(57) ABSTRACT

In aspect, the disclosure includes a method of configuring a MIMO wideband receiver. The method would include estimating, on a SISO basis, a set of post-processing parameters for a plurality of receiver channels; receiving, by each of the plurality of receiver channels, a first test signal which is transmitted from a first transmitter channel on a MIMO basis; calculating a first set of crosstalk parameters in response to receiving the first test signal; receiving, by each of the plurality of receiver channels, a second test signal which is transmitted from a second transmitter channel on the MIMO basis; calculating a second set of crosstalk parameters in response to receiving second test signal; and calculating the set of post-processing parameters based on the first set of crosstalk parameters and the second set of crosstalk parameters by cancelling a crosstalk interference among plurality of receiver channels.

### CROSS-REFERENCE TO RELATED APPLICATION

This application claims the priority benefit of U.S. provisional application Ser. No. 62/872,251, filed on Jul. 10, 2019. The entirety of the above-mentioned patent application is hereby incorporated by reference herein and made a part of this specification.

### TECHNICAL FIELD

The disclosure is directed to a method of configuring a MIMO wideband receiver, a method of configuring a MIMO wideband transmitter, and a MIMO wideband receiver using the same method, and a MIMO wideband transmitter using the same method.

### BACKGROUND

Currently, the multi-antenna technology aims to achieve a high level of spectral efficiency so as to be utilized by the latest wireless communication system such as the 5G communication system which is under development. The 5G communication system may use a large number of multi-antenna systems which would combine multiple radio frequency (RF) transmitters and receivers (i.e. transceivers). However, when RF components are densely packed in a small area of a circuit or of a chip, without meticulous configurations, crosstalk among RF components may inevitably occur due to signal mixings which would cause a degradation of the RF signals within the circuit or the chip.

Historically, the technology to minimize crosstalk has been limited to narrowband systems (e.g. a few MHz). Nevertheless, the technique for solving the crosstalk problem has to be extended to the current and the future communication systems as the bandwidth (BW) of the current communication system has been extended to about 80 MHz or even 100 MHz. In the future, the BW could be extended to 500 MHz, and thus such problem could be even more conspicuous as the crosstalk may occur in the form of coupling interference between multi-input multi-output (MIMO) ports among a wide variety of broadband applications.

Even though many solutions have been proposed to overcome the MIMO crosstalk problem, most of the solutions are based on the circumstance in which the crosstalk problem could be more or less frequency independent. Also, most of the solutions are proposed as a theoretical conjecture for academic research and thus might not actually be practical for solving MIMO crosstalk problem in a frequency dependent circumstance. For instance, some solutions are not MIMO but are related to mostly for solving the crosstalk problem only at the transmitting end or for solving the crosstalk problem by compensating at the receiving end. Therefore, may of the solutions might not adequately reduce crosstalk problems in the current communication system and thus might not result in a system wide improvement of the signal quality of a transceiver system. Thus, there has to be a different mechanism of configuring a MIMO wideband transceiver so as to reduce the crosstalk problem of the MIMO wideband transceiver.

### SUMMARY OF THE DISCLOSURE

Accordingly, the disclosure is directed to a method of configuring a MIMO wideband receiver, a method of configuring a MIMO wideband transmitter, and a MIMO wideband receiver using the same method, and a MIMO wideband transmitter using the same method.

In an aspect, the disclosure is directed to a method of configuring a MIMO wideband receiver. The method would include not limited to: estimating, on a single-input and single-out (SISO) basis, a set of post-processing parameters for a plurality of receiver channels; receiving, by each of the plurality of receiver channels, a first test signal which is transmitted from a first transmitter channel on a MIMO basis; calculating a first set of crosstalk parameters in response to receiving the first test signal; receiving, by each of the plurality of receiver channels, a second test signal which is transmitted from a second transmitter channel on the MIMO basis; calculating a second set of crosstalk parameters in response to receiving second test signal; and calculating the set of post-processing parameters based on the first set of crosstalk parameters and the second set of crosstalk parameters by cancelling a crosstalk interference among plurality of receiver channels.

In another aspect, the disclosure is directed to a method of configuring a MIMO wideband transmitter. The method would include not limited to: transmitting on a MIMO basis, through a first transmitter channel of a plurality of transmitting channels, a first test signal to be received by a first receiver channel; transmitting on the MIMO basis, through a second transmitter channel of the plurality of transmitting channels, a second test signal to be received by a second receiver channel; determining, a first received signal received by the first receiver channel and determining a second received signal received by the second receiver channel; estimating, a set of coupling parameters for the plurality of transmitter channels based on the first received signal and the second received signal; and calculating, based on the set of coupling parameters, a set of pre-processing compensation parameters by cancelling a crosstalk interference among plurality of transmitter channels.

In another aspect, the disclosure is directed to a MIMO wideband receiver. The receiver would include not limited to: a wireless receiver comprising a plurality of receiver channels including a first receiver channel and a second receiver channel; and a processor coupled to the wireless receiver and configured to: estimate, on a single-input and single-out (SISO) basis, a set of post-processing parameters for the plurality of receiver channels; receive, by each of the plurality of receiver channels, a first test signal which is transmitted from a first transmitter channel on a MIMO basis; calculate a first set of crosstalk parameters in response to receiving the first test signal; receive, by each of the plurality of receiver channels, a second test signal which is transmitted from a second transmitter channel on the MIMO basis; calculate a second set of crosstalk parameters in response to receiving second test signal; and calculate the set of post-processing parameters based on the first set of crosstalk parameters and the second set of crosstalk parameters by cancelling a crosstalk interference among plurality of receiver channels.

In another aspect, the disclosure is directed to a MIMO wideband transmitter. The transmitter would include not limited to: a wireless transmitter including a plurality of transmitter channels comprising a first transmitter channel and a second transmitter channel; and a processor coupled to the wireless transmitter and configured to: transmit on the MIMO basis, through the first transmitter channel, a first test signal to be received by a first receiver channel and simultaneously transmitting, through the second transmitter channel, a second test signal to be received by a second receiver channel; determine, a first received signal received by the first receiver channel and determining a second received signal received by the second receiver channel; estimate, a set of coupling parameters for the plurality of transmitter channels based on the first received signal and the second received signal; and calculate, based on the set of coupling parameters, a set of pre-processing compensation parameters by cancelling a crosstalk interference among plurality of transmitter channels.

In order to make the aforementioned features and advantages of the present disclosure comprehensible, exemplary embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also, the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 shows the above described concept in a flow chart according to one of the exemplary embodiments of the disclosure.

FIG. 2 shows the hardware diagram of a transmitter and a receiver according to one of the exemplary embodiments of the disclosure.

FIG. 3 shows a simplified conceptual diagram of an overall MIMO wideband transceiver system architecture according to one of the exemplary embodiments of the disclosure.

FIG. 4 illustrates a derivation of a conceptual model of a MIMO transmitter architecture according to one of the exemplary embodiments of the disclosure.

FIG. 5 illustrates a derivation of a conceptual model of a MIMO receiver architecture according to one of the exemplary embodiments of the disclosure.

FIG. 6 is a flow chart which shows steps of reducing crosstalk of a MIMO transmitter according to one of the exemplary embodiments of the disclosure.

FIG. 7 is a model block diagram of a MIMO transmitter having in-phase quadrature (IQ) imbalance (IQI) as well as coupling distortion according to one of the exemplary embodiments of the disclosure.

FIG. 8 shows a MIMO transmitter performing crosstalk pre-compensation according to one of the exemplary embodiments of the disclosure.

FIG. 9 illustrates using only q₁ (n) and q₂(n) for performing crosstalk pre-compensation according to one of the exemplary embodiments of the disclosure.

FIG. 10 illustrates a 2×2 MIMO transmitter architecture according to one of the exemplary embodiments of the disclosure.

FIG. 11 illustrates a block diagram for performing crosstalk calibration process for a transmitter according to one of the exemplary embodiments of the disclosure.

FIG. 12 illustrates a schematic diagram of a joint estimation process for performing the crosstalk adjustment of a MIMO transmitter according to one of the exemplary embodiments of the disclosure.

FIG. 13 is a flow chart which describes the steps of calculating the post-processing parameters for cancelling crosstalk according to one of the exemplary embodiments of the disclosure.

FIG. 14 is a system block diagram of a MIMO receiver having IQI and coupling distortion.

FIG. 15 shows a MIMO receiver performing crosstalk post-compensation according to one of the exemplary embodiments of the disclosure.

FIG. 16 is a conceptual diagram showing the relationship between crosstalk parameters and post-processing parameters according to one of the exemplary embodiments of the disclosure.

FIG. 17 is a block diagram which shows calculating post-processing parameters of a MIMO receiver according to one of the exemplary embodiments of the disclosure.

FIG. 18 is a conceptual diagram for testing a MIMO receiver according to one of the exemplary embodiments of the disclosure.

FIG. 19 is a flow chart which shows a procedure of reducing crosstalk of a MIMO receiver according to one of the exemplary embodiments of the disclosure.

FIG. 20 is a flow chart which shows steps of performing a crosstalk estimation and compensation procedure for a MIMO transceiver system according to one of the exemplary embodiments of the disclosure.

FIG. 21 is a system block diagram of a MIMO transceiver system according to one of the exemplary embodiments of the disclosure.

FIG. 22 shows a system architecture of a MIMO transceiver system which utilizes the disclosed method according to one of the exemplary embodiments of the disclosure.

FIG. 23 shows a block diagram of a process of reducing crosstalk at the receiving end of a MIMO transceiver system according to one of the exemplary embodiments of the disclosure.

FIG. 24 is a block of the MIMO transceiver system after processing through the receiving end according to one of the exemplary embodiments of the disclosure.

FIG. 25 is a flow chart showing steps of crosstalk reducing procedures at the transmitting end and the receiving end after having estimated processing parameters for the transceiver system according to one of the exemplary embodiments of the disclosure.

FIG. 26 is a block diagram which shows using information from the receiving end to perform crosstalk reducing procedures at the transmitting end and the receiving end according to one of the exemplary embodiments of the disclosure.

### DETAILED DESCRIPTION OF DISCLOSED EMBODIMENTS

Reference will now be made in detail to the present exemplary embodiments of the disclosure, examples of which are illustrated in the accompanying drawings. Wherever possible, the same reference numbers are used in the drawings and the description to refer to the same or like parts.

As described previously, the current multi-antenna technology has to be able to provide more than 80 MHz of bandwidth which would result in continuous miniaturization and integration of RF components. As a MIMO system transmits and receives multiple RF signals within a small-area of a circuit board or an integrated circuit (IC) chip, crosstalk between RF signals may cause unintended signal mixing, signal distortion, and a reduction of the quality of the signal.

Based on the above, this disclosure provides a method of reducing crosstalk of a MIMO transceiver system by calibrating the MIMO transceiver of a multi-antenna wireless communication system. The disclosure uses the digital signal processing to estimate parameters of a wideband crosstalk response and compensate for the wideband crosstalk distortion. A pre-compensation procedure could be performed at the transmitter end, and a post-compensation procedure could be provided to the receiver. The disclosure includes various exemplary embodiments for performing the method of reducing crosstalk of a MIMO transceiver system. The exemplary embodiments include performing the above described method according to the crosstalk information at the transmitting end only, at the receiving end only, at both the transmitting end and the receiving end, and other variations of such. Experiments have been performed to verify the effects of the disclosure and experimental results are included toward the end of the disclosure.

According to the exemplary embodiment of performing the above described method to reduce crosstalk at the transmitting end only, a mathematical model of the transmitting end is provided as well as the procedures for tuning the transmitter to order to estimate the coupling parameters of the transmitting end through a least square (LS) method. During the performance of the LS method and after the matrix has been arranged, pre-compensation parameters of the transmitting end could be obtained. According to the exemplary embodiment of performing the above described method to reduce crosstalk at the receiving end only, a mathematical model of the receiving end is provided. The process of tuning the receiver would first include estimating the crosstalk parameters of the receiving end according to various conditions. After an inverse matrix operation is performed, post-processing parameters could be obtained. The signal at the receiving end could then be post-processed to compensate for the crosstalk and to detect the received value. According to the exemplary embodiment of performing the above described method to reduce crosstalk at both the transmitting end and the receiving end, a mathematical model of the corresponding transceiver architecture is provided. The procedure would include estimating the calibration process and eliminating the respective crosstalk signals in the transceiver. Overall, for each of the exemplary embodiments, the above described method would involve generating or assuming a mathematical model based on relevant components of a transceiver system, estimating the crosstalk factor based on the mathematical model, and performing the compensation based on the estimated crosstalk factor.

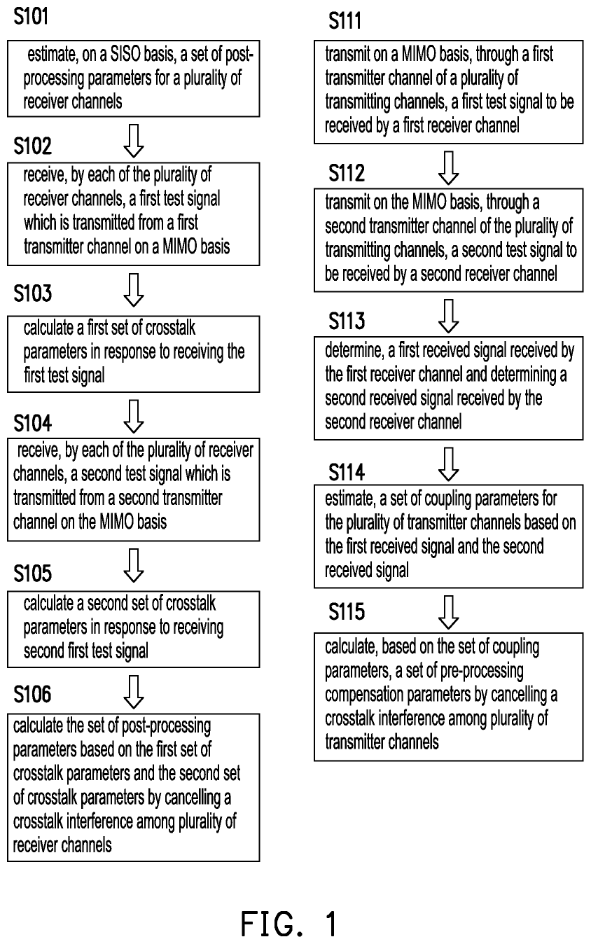

FIG. 1 shows steps of the method of configuring a MIMO wideband receiver and steps of the method of configuring a MIMO wideband transmitter according to one of the exemplary embodiments of the disclosure. The steps performed by a receiver would include not limited to steps S101˜S106, and steps performed by a transmitter would include not limited to S111˜S115. Referring to FIG. 1, in step S101, the receiver would estimate, on a SISO basis, a set of post-processing parameters (e.g. P1, P2, P3 P4) for a plurality of receiver channels (e.g. RX1 RX2). In step S102, the receiver would receive, by each of the plurality of receiver channels, a first test signal (e.g. U₁(n)) which is transmitted from a first transmitter channel (e.g. TX1) on a MIMO basis. In step S103, the receiver would calculate a first set of crosstalk parameters (e.g. e₁₁ e₁₂ e₂₁ e₂₂) in response to receiving the first test signal. In step S104, the receiver would receive, by each of the plurality of receiver channels, a second test signal (e.g. U₂ (n)) which is transmitted from a second transmitter channel (e.g. TX2) on the MIMO basis. In step S105, the receiver would calculate a second set of crosstalk parameters (e.g. f₁₁ f₁₂ f₂₁ f₂₂) in response to receiving second test signal. In step S106, the receiver would calculate the set of post-processing parameters based on the first set of crosstalk parameters and the second set of crosstalk parameters by cancelling a crosstalk interference among plurality of receiver channels.

According one of the exemplary embodiments, estimating, on the SISO basis, the set of post-processing parameters for the plurality of receiver channels may involve estimating a second post-processing parameter (e.g P2) and a third post-processing parameter (e.g. P3) only between the first transmitter channel and the first receiver channel, switching from between the first transmitter channel and the first receiver channel (e.g. RX1) to between the second transmitter channel and the second receiver channel (e.g. RX2), and estimating a first post-processing parameter (e.g. P1) and a fourth post-processing parameter (e.g. P4) only between the first transmitter channel and the first receiver channel. The set of post-processing parameters may include the first post-processing parameter (e.g. P1), the second post-processing parameter (e.g. P2), the third post-processing parameter (e.g. P3), and the fourth post-processing parameter (e.g. P4).

According one of the exemplary embodiments, receiving, by each of the plurality of receiver channels, the first test signal which is transmitted from the first transmitter channel on the MIMO basis may involve receiving, by a first receiver channel of the plurality of receiver channels, a first test signal which is transmitted from a first transmitter channel on a MIMO basis while not receiving from the second transmitter channel and grounding the second receiver channel; receiving, by a second receiver channel of the plurality of receiver channels, the first test signal which is transmitted from a first transmitter channel on the MIMO basis while not receiving from the first transmitter channel and grounding the first receiver channel.

According one of the exemplary embodiments, calculating the first set of crosstalk parameters in response to receiving the first test signal may involve obtaining a first crosstalk parameter (e.g. e₁₁) and a second crosstalk parameter (e.g. e₁₂) based on the first test signal received by the first receiver channel and obtaining a third crosstalk parameter (e.g. e₂₁) and a fourth crosstalk parameter (e.g. e₂₂) based on the first test signal received by the second receiver channel. The first set of crosstalk parameters may include the first crosstalk parameter, the second crosstalk parameter, the third crosstalk parameter, and the fourth crosstalk parameter.

According one of the exemplary embodiments, receiving, by each of the plurality of receiver channels, the second test signal which is transmitted from the second transmitter channel on the MIMO basis may involve receiving, by a first receiver channel of the plurality of receiver channels, a second test signal which is transmitted from a second transmitter channel on a MIMO basis while not receiving from the first transmitter channel, grounding the second receiver channel; receiving, by a second receiver channel of the plurality of receiver channels, the second test signal which is transmitted from a second transmitter channel on the MIMO basis while not receiving from the first transmitter channel, and grounding the first receiver channel. The above described first test signal and the second test signal could be different quadrature phase shift keying (QPSK) training sequences.

According one of the exemplary embodiments, calculating the second set of crosstalk parameters in response to receiving the second test signal may involve obtaining a fifth crosstalk parameter (e.g. f₁₁) and a sixth crosstalk (e.g. f₁₂) parameter based on the second test signal received by the first receiver channel, and obtaining a seventh crosstalk parameter (e.g. f₂₁) and an eighth crosstalk parameter (e.g. f₂₂) based on the second test signal received by the second receiver channel. The second set of crosstalk parameters comprising a fifth crosstalk parameter, a sixth crosstalk parameter, a seventh crosstalk parameter, and an eighth crosstalk parameter.

According one of the exemplary embodiments, calculating the set of post-processing parameters based on the first set of crosstalk parameters may further involve estimating the first crosstalk parameter (e.g. e₁₁) and the second crosstalk parameter (e.g. e₁₂) based on a least square technique, and calculating the set of post-processing parameters based on the second set of crosstalk parameters may further involve estimating the fifth crosstalk parameter and the sixth crosstalk parameter based on a least square technique.

According one of the exemplary embodiments, the method may further include determining whether the set of post-processing parameters cancel out crosstalk among the plurality of receiver channels.

As for the transmitter, in step S111, the transmitter would transmit on a MIMO basis, through a first transmitter channel of a plurality of transmitting channels, a first test signal to be received by a first receiver channel. In step, the transmitter would transmit on the MIMO basis, through a second transmitter channel of the plurality of transmitting channels, a second test signal to be received by a second receiver channel. In step S113, the transmitter would determine, a first received signal received by the first receiver channel and determine a second received signal received by the second receiver channel. In step S114, the transmitter would estimate, a set of coupling parameters (e.g., c₁₁, c₁₂, c₂₁, c₂₂) for the plurality of transmitter channels based on the first received signal and the second received signal. In step S115, the transmitter would calculate, based on the set of coupling parameters, a set of pre-processing compensation parameters (e.g. q₁ q₂ q₃ q₄) by cancelling a crosstalk interference among plurality of transmitter channels.

According to one of the exemplary embodiments, transmitting by the first transmitter channel the first test signal to be received by the first receiver channel and transmitting by the second transmitter channel the second test signal to be received by the second receiver channel may occur simultaneously. The above described first test signal and the second test signal could be different QPSK training sequences. The above described estimating the set of coupling parameters could be performed based on a least square technique. The above described estimating the set of coupling parameters may involve determining the first received signal and the second received signal by setting the set of pre-processing compensation parameters to zero.

According to one of the exemplary embodiments, the method may further include determining whether the transmitter has cancelled the crosstalk interference among plurality of transmitter channels by applying the pre-processing compensation parameters to a processor of the transmitter. Estimating the set of coupling parameters may further involve assuming the first receiver channel and the second receiver channel as an ideal receiver. The pre-processing compensation parameters could be applied to the processor of the transmitter only once.

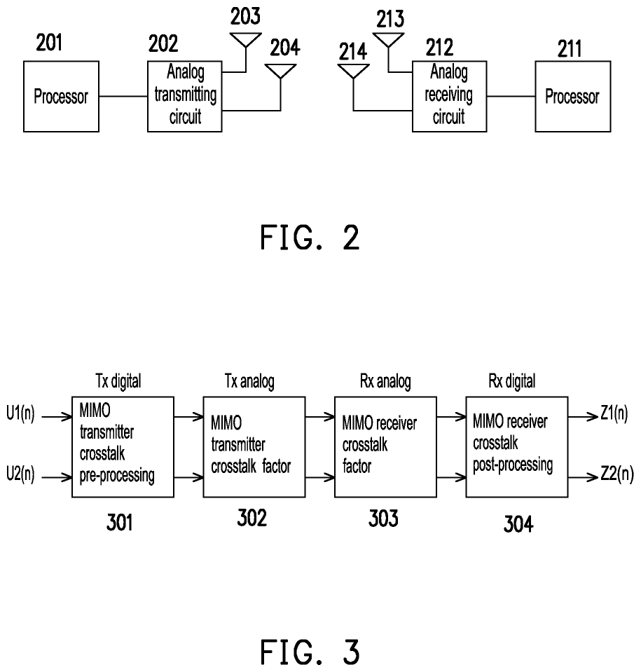

FIG. 2 shows the hardware diagram of a transmitter and a receiver according to one of the exemplary embodiments of the disclosure. It should be noted that the transmitter end which comprising a processor 201, an analog transmitting circuit 202, a first transmitter channel 203 and a second transmitter channel 204 and the receiver end, which comprising a processor 211, an analog receiving circuit 212, a first receiver channel 213 and a second receiver channel 214 could be independently integrated as two separate chips or integrated as a single chip, could be located on the same circuit board or located on two separate circuit boards that are electrically disconnected. The processor 201 of the transmitter could be one or more ICs having processing capabilities and would control the analog transmitting circuit 202 to implement functions of the above describe method of configuring a MIMO wideband transmitter and its embodiments. The processor 201 may implement functions of ‘TX digital’ as show in the drawings and described in the corresponding written descriptions, and the analog transmitting circuit 202 may implement functions of ‘TX analog’ as show in the drawings and described in the corresponding written descriptions. The processor 201 may output digital signals to be digitized by a digital (D/A) converter into an analog baseband signal which is then upconverted into RF frequency and transmitted through a MIMO antenna array of the transmitting circuit 202. The analog transmitting circuit 202 and its MIMO antenna array may have multiple channels including a first transmitter channel 203 and a second transmitter channel 204.

The processor 211 of the receiver could be one or more ICs having processing capabilities and would control the analog receiving circuit 212 to implement functions of the above describe method of configuring a MIMO wideband receiver and its embodiments. The processor 211 may implement functions of ‘RX digital’ as show in the drawings and described in the corresponding written descriptions, and the analog receiving circuit 212 may implement functions of ‘RX analog’ as show in the drawings and described in the corresponding written descriptions. The processor 211 may receive digital signals which were digitized by an analog-digital digital (A/D) converter from an analog baseband signal which has been down-converted from RF frequency and received through a MIMO antenna array of the analog receiving circuit 212. The analog receiving circuit 212 and its MIMO antenna array may have multiple channels including a first receiver channel 213 and a second receiver channel 214.

FIG. 3 shows a simplified conceptual diagram of an overall MIMO wideband transceiver system architecture according to one of the exemplary embodiments of the disclosure. In transmitter block 301, the transmitter would obtain a digital baseband transmitting signal by using a processor (e.g. 201) for estimating the crosstalk factor based on a mathematical model. Next, the transmitter block 301 would perform a pre-processing procedure on the digital baseband transmitting signal and subsequently perform a digital to analog (D/A) conversion on the pre-processed digital baseband transmitting signal to generate a pre-processed analog baseband transmitting signal which contains a crosstalk factor. The transmitter block 302 would up-convert the pre-processed analog baseband transmitting signal into a pre-processed analog RF transmitting signal to be transmitted by using a MIMO antenna array. The pre-processed analog RF transmitting signal is to be received by the MIMO receiver antenna array of the receiver block 303 as an analog RF receiving signal which is assumed to contain the crosstalk factor. The analog RF receiving signal would then be down-converted into an analog baseband receiving signal.

The receiver block 304 may perform an analog-to-digital (A/D) conversion on the analog baseband receiving signal to generate a digital baseband receiving signal. Subsequently, the receiver block 304 would perform a post-processing procedure by using a processor (e.g. 211) on the digital baseband receiving signal to estimate the original digital baseband transmitting signal based on the crosstalk factor.

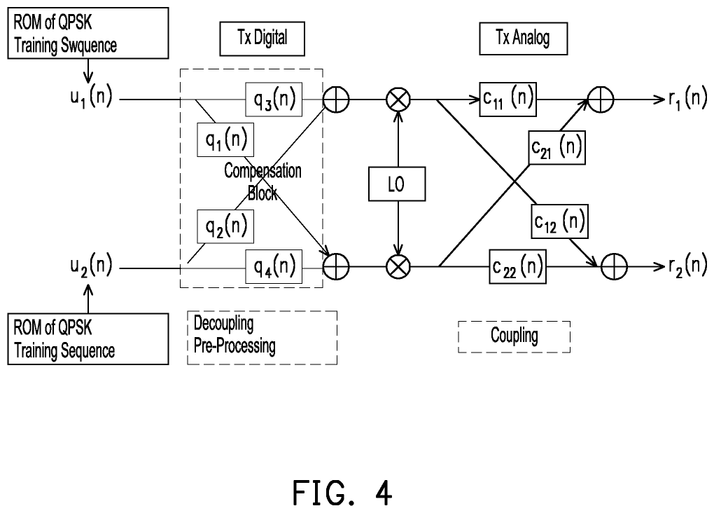

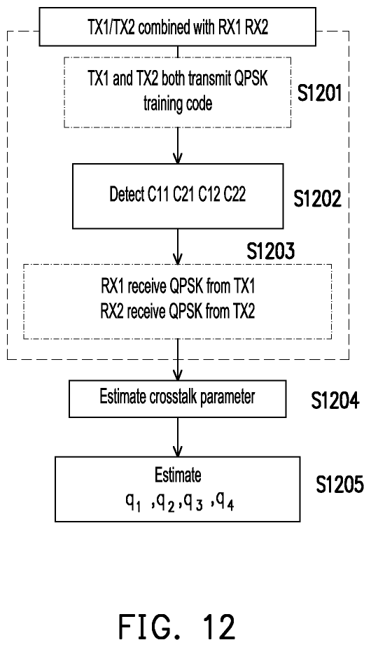

MIMO wideband transceiver system could be demarcated into a transmitting end (i.e. MIMO transmitter (e.g. 201 202 203 204)) and a receiving end (i.e. MIMO transmitter (e.g. 211 212 213 214)). To further describe the method of configuring the wideband MIMO transmitter and the structure of the wideband MIMO transmitter, the disclosure provides several exemplary embodiments as shown in FIG. 4˜FIG. 12. FIG. 4 is an architecture of a transmitting end according to one of the exemplary embodiments of the disclosure. For the architecture of FIG. 4 which shows the transmitting end, the pre-processing procedure would include a pre-compensation procedure. For the ease of elucidation, a 2×2 MIMO transmitter and a 2×2 MIMO receiver is assumed. In FIG. 4, a first transmitter channel is assumed to transmit a first transmitting signal (U₁(n)), and a second transmitter channel is assumed to transmit a second transmitting signal (U₂(n)). U₁(n) would experience an interference signal based on a signal from U₂(n) and vice versa. The interference signal would mix with U₁(n) to cause the first output r₁(n) to be distorted. Similarly, the second output r₂(n) would also be distorted due to the interference from U₁(n). However, by using the algorithms to be provided in latter parts of the disclosure, the crosstalk factor c₁₁(n), c₂₁(n), c₁₂(n), and c₂₂(n) at the transmitting end could be estimated so as to subsequently derive the pre-compensation matrix q₁, q₂, q₃, q₄ accordingly. Next, the pre-compensation matrix could be placed as a part of the transmitter block (e.g. 201) so as to pre-compensate for the crosstalk to be received by the receiving end in order to maintain overall performance of the transceiver system.

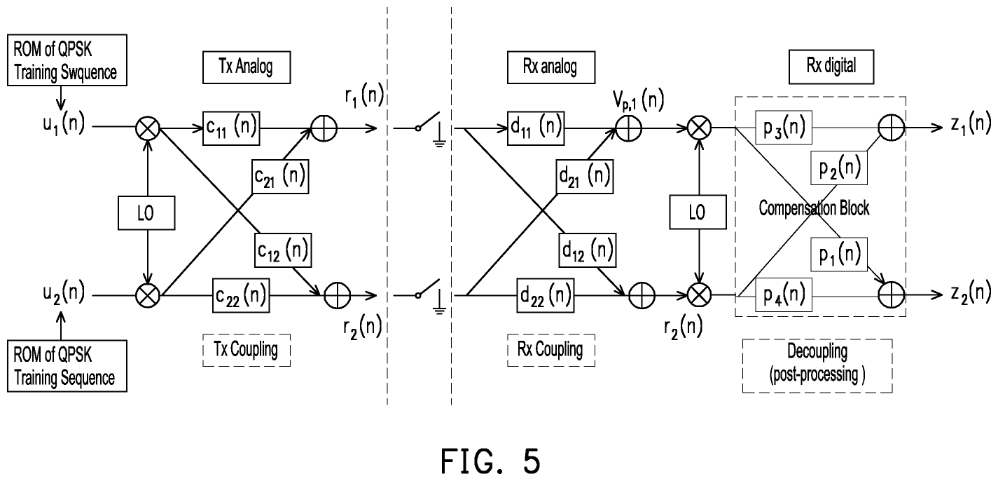

FIG. 5 extends upon the concepts of FIG. 4 and includes a wideband MIMO receiver (i.e. receiving end). As shown in FIG. 5, the crosstalk problem also exists in the receiving end since V_{p,1}(n) receives not only intended signal from a first channel but also unintended signal, destined toward V_{p,2}(n), from a second channel. Therefore, a pre-processing procedure would be performed to cancel out the crosstalk shared among receiving channels. In particular, the receiver processing parameters P₁, P₂, P₃, P₄ would be configured to resolve the receiver crosstalk factor d₁₁, d₁₂, d₁₃, d₁₄. As described previously, the crosstalk may occur as the result of signal mixing between U1(n) and U2(n) at the transmitting end to cause distortion at r₁(n) and r₂(n). However, the crosstalk parameters could be obtained by an algorithm to be described in further detail as the post-processing correlation matrix is derived, and then the post-processing parameters P₁, P₂, P₃, P₄ could be obtained for performing the post-processing procedure by the receiving end. Consequently, the crosstalk factor could be suppressed accordingly.

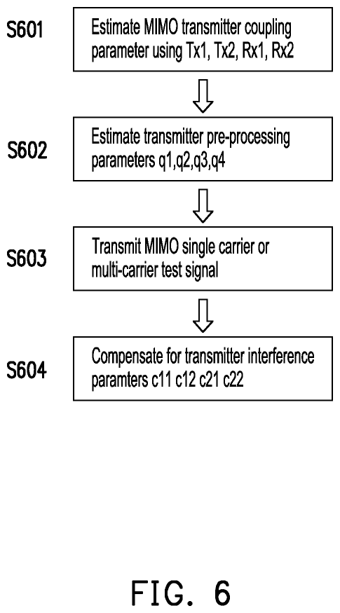

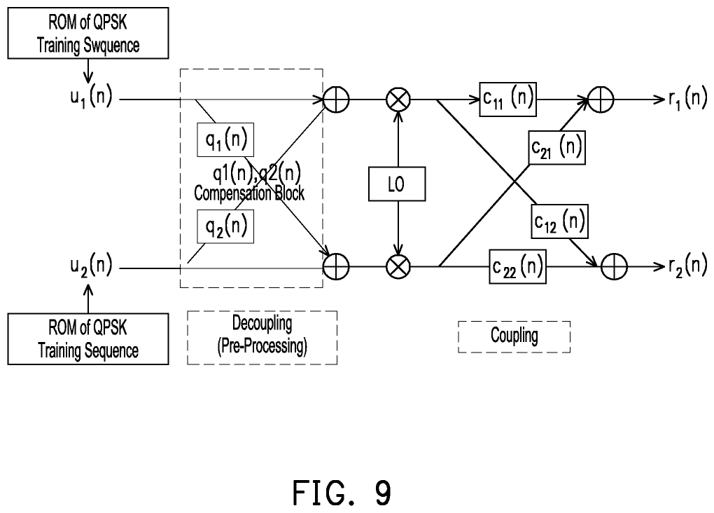

To describe the estimation and pre-compensation for the crosstalk at the transmitting end of a wideband communication system, the disclosure provides further details as shown in FIG. 6˜FIG. 9 and their corresponding descriptions. FIG. 6 is a flow chart which shows steps of reducing crosstalk of a MIMO transmitter according to one of the exemplary embodiments of the disclosure. In step S601, the transmitter would estimate MIMO transmitter coupling parameters for at least two transmitting channels and at least two receiving channels. In step S602, the transmitter would estimate transmitter pre-processing parameters (e.g. q₁, q₂, q₃, q₄). In step S603, the transmitter would transmit a MIMO single carrier test signal or a MIMO multi-carrier test signal. In step S604, the transmitter would compensation for the transmitter pre-processing (or interference) parameters (e.g. c₁₁, c₁₂, c₂₁, c₂₂).

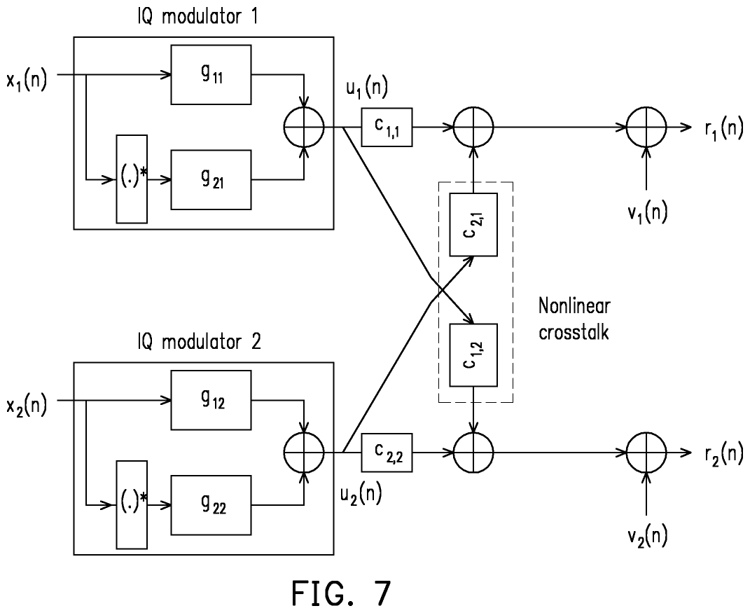

To further explain the above steps, FIG. 7 shows a model block diagram of a MIMO transmitter having in-phase quadrature (IQ) imbalance (IQI) as well as coupling distortion according to one of the exemplary embodiments of the disclosure. The crosstalk factor at the transmitting end refers to the scenario where a cross-frequency interference signal is generated among multiple channels of a wideband RF circuit after baseband signals have been upconverted into RF frequency signals. There could be multiple crosstalk factor signals generated on the chip as the crosstalk phenomenon may occur among multiple RF transmitters. This crosstalk factor may affect any one of the multiple channels causing distortions and affecting the performance of the transceiver.

When a signal is transmitted through a wideband transmitter having multiple inputs, the signal is bound to be accompanied by the IQ Imbalance (IQI) of the broadband radio frequency, and then the crosstalk response (coupling/crosstalk) is generated through the crosstalk scene of the transmitter as shown in FIG. 7 which could be used as a model to represent a main signal and a coupled signal due to the cross talk phenomenon. The received signal r₁(n) could be represented by equation 1.

$${r}_{l} ( n ) = {u}_{l} ( n ) + {\sum }_{{ }_{m = 1 , m \neq l}}^{M} {c}_{m l} ( n ) ⊗ {u}_{m} ( n ) + {v}_{l} ( n ) \qquad equation 1$$

In equation 1, ⊗ stands for convolution. uₘ (n): stands the I/Q modulation signal (with broadband “IQ” imbalance factor) for the m^{th} antenna. cₘₗ(n): stands for the filtered response value (L_cm length) of the m^{th} antenna to the crosstalk of the l^{th} antenna transmitter, where cₘₗ(n)=[cₘₗ(n), cₘₗ(n−1), . . . , cₘₗ(n−L_{cm}+1)]^{T}. vₗ(n): indicates the noise of the l^{th} antenna.

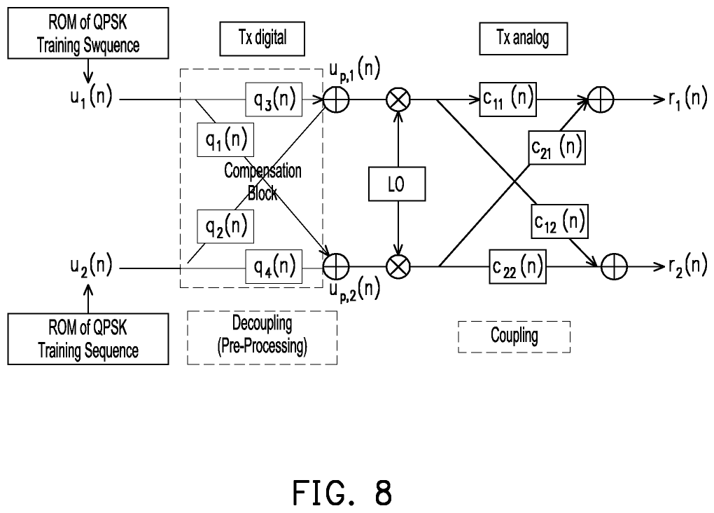

FIG. 8 shows a MIMO transmitter crosstalk pre-compensation architecture according to one of the exemplary embodiments of the disclosure. In this disclosure, it is assumed that the broadband RF imperfection factor has been calibrated, and for the multiple inputs transmitter, the crosstalk factor response and its corresponding crosstalk adjustment technique is provided for a 2×2 MIMO broadband system. The same technique could be extended to a N×N MIMO broadband system where N is greater than 2 by using the same or a similar principle.

Referring to FIG. 8, at the digital transmitting end (Tx digital), U₁(n) and U₂(n) are the original transmission signal without crosstalk, and U₁(n) and U₂(n) are input into a crosstalk pre-compensation filter represented by q₁(n), q₂(n), q₃(n), q₄(n) for pre-processing, and the pre-processed signals u_{p,1}(n) and u_{p,2}(n) are obtained. When the MIMO RF transmitter crosstalk occurs at the analog end (Tx analog), the first RF transmission signal r₁(n) and the second RF transmission signal r₂(n) would both be affected. As long as the pre-compensation parameters q₁(n), q₂(n), q₃(n), q₄(n) can be accurately estimated, it would help r₁(n) and r₂(n) to avoid crosstalk and to maintain the original signal integrity.

In order to estimate the crosstalk factor of the transmitter in a wideband MIMO system, the Least Square (LS) technique could be used to estimate the broadband crosstalk factor at the transmitting end. Such technique may enhance the interference effect on the unknown signal and avoid high computational complexity. Next, and then estimate the transmitter pre-compensation vector of the transmitter could be estimated based on the algorithms to be provided in order to solve the crosstalk factor among different channels of the MIMO transmitter so as to achieve high-quality communication requirements of the broadband MIMO system. The technique is provided as follows.

First, there is no pre-compensation action before estimating the crosstalk factors c₁₁(n), c₂₁(n), c₁₂(n), c₂₂(n), and thus q₁(n)=q₂(n)=q₃(n)=q₄(n)=0. Therefore, for the 1=1 and m=2 scenarios, m=2 is the crosstalk signal of the second transmitter channel (TX2), so the signal to be received by the first receiver channel (RX1), r₁(n), could be expressed by equation 2.

r₁(n)=c₁₁(n)⊗u₁(n)+c₂₁(n)ßu₂(n) equation 2

for the 1=2 and m=1 scenarios, m=1 is the crosstalk signal of the first transmitter channel (TX1), so the signal to be received by the second receiver channel (RX2), r₂(n), could be expressed as equation 3.

r₂(n)=c₂₂(n)⊗u₂(n)+c₁₂(n)⊗u₁(n) equation 3

Equation 2 could be expressed in the matrix form which is shown as equation 4.

$${r}_{1} = {U}_{1} {c}_{11} + {U}_{2} {c}_{21} \\ ∴ {r}_{1} = [ {U}_{1} {U}_{2} ] [ \begin{matrix}{c}_{11} \\ {c}_{21}\end{matrix} ] \qquad equation 4$$

Equation 3 could be expressed in the matrix form which is shown as equation 5.

$${r}_{2} = {U}_{1} {c}_{12} + {U}_{2} {c}_{22} \\ ∴ {r}_{2} = [ {U}_{1} {U}_{2} ] [ \begin{matrix}{c}_{12} \\ {c}_{22}\end{matrix} ] \qquad equation 5$$

In equation 4 and 5, r₁ and r₂ are the vector representations of r₁(n) and r₂(n), U₁ and U₂ are convolution matrix representations of u₁(n) and u₂(n), and u=[u1 u2].

However, when estimating the crosstalk factor at the transmitting end, two sets of QPSK modulation signals could be used as the known training codes for u₁(n) and u₂(n), so equation 4 could be used with the least squares technique so as to allow the signal transmitted from TX1 be known based on the training code to in order to obtain the received signal from RX1 by using equation 6.

$$[ \begin{matrix}{\hat{c}}_{11} \\ {\hat{c}}_{21}\end{matrix} ] = {U}^{+} {r}_{1} \qquad equation 6$$

Similarly, equation 5 could be used with the least squares technique so as to allow the signal transmitted from TX2 be known based on the training code in order to obtain the received signal from RX2 by using equation 7.

$$[ \begin{matrix}{\hat{c}}_{12} \\ {\hat{c}}_{22}\end{matrix} ] = {U}^{+} {r}_{2} \qquad equation 7$$

In equation 7, U⁺=(U^{H}U)⁻¹U^{H}.

Based on equation 6 and equation 7 as shown above, the unknown parameters c₁₁, c₂₁, c₂₂, c₁₂ could be solved, and then base on the algorithm to be presented, the pre-compensation parameters q₁, q₂, q₃, q₄ of the transmitting end could be derived.

FIG. 9 shows using only q₁(n) and q₂(n) for performing the pre-compensation procedure according to one of the exemplary embodiments of the disclosure. Assuming that the signal of TX1 is u_{p,1}(n), then u_{p,1}(n) could be represented as equation 8.

TX_{p,1}: u_{p,1}(n)=u₁(n)+q₂(n)⊗u₂(n) equation 8

Assuming that the signal of TX2 is u_{p,2}(n), then u_{p,2}(n) could be represented as equation 9.

TX_{p,2}: u_{p,2}(n)=u₂(n)+q₁(n)⊗u₁(n) equation 9

If u_{p,1}(n) from equation 8 is replaced by u₁(n) of equation 2, then it can represent the to be received signal r₁(n) after the TX1 signal is pre-compensated only by the crosstalk factor q₁(n), q₂(n) which are used to compensate for the received signal r₁(n) as shown in equation 10.

$$\begin{matrix}{r}_{1} ( n ) = {c}_{11} ( n ) ⊗ {u}_{p , 1} ( n ) + {c}_{21} ( n ) ⊗ {u}_{p , 2} ( n ) \\ = {c}_{11} ( n ) ⊗ \{ {u}_{1} ( n ) + {q}_{2} ( n ) ⊗ {u}_{2} ( n ) \} + \\ {c}_{21} ( n ) ⊗ \{ {u}_{2} ( n ) + {q}_{1} ( n ) ⊗ {u}_{1} ( n ) \}\end{matrix} \qquad equation 10$$

The equation 10 could be further expanded to express r₁(n) as equation 11.

$${r}_{1} ( n ) = \{ {c}_{11} ( n ) + {c}_{21} ( n ) ⊗ {q}_{1} ( n ) \} ⊗ {u}_{1} ( n ) + \{ {c}_{11} ( n ) ⊗ {q}_{2} ( n ) + {c}_{21} ( n ) \} ⊗ {u}_{2} ( n ) ⇑ ≡ 0 \qquad equation 11$$

If u_{p,2}(n) from equation 8 is replaced by u₂(n) of equation 3, then it can represent the to be received signal r₂(n) after the TX2 signal is compensated by the pre-compensation parameter which are used for eliminating the crosstalk factor as shown in equation 12.

$$\begin{matrix}{r}_{2} ( n ) = {c}_{22} ( n ) ⊗ {u}_{p , 2} ( n ) + {c}_{12} ( n ) ⊗ {u}_{p , 1} ( n ) \\ = {c}_{22} ( n ) ⊗ \{ {u}_{2} ( n ) + {q}_{1} ( n ) ⊗ {u}_{1} ( n ) \} + \\ {c}_{12} ( n ) ⊗ \{ {u}_{1} ( n ) + {q}_{2} ( n ) ⊗ {u}_{2} ( n ) \}\end{matrix} \qquad equation 12$$

The equation 12 could be further expanded to express r₁(n) as equation 13.

$${r}_{2} ( n ) = \{ {c}_{22} ( n ) ⊗ {q}_{1} ( n ) + {c}_{12} ( n ) \} ⊗ {u}_{1} ( n ) \\ ⇑ ≡ 0 + \\ \{ {c}_{22} ( n ) + {c}_{12} ( n ) ⊗ {q}_{2} ( n ) \} ⊗ {u}_{2} ( n ) \qquad equation 13$$

Further, in equation 11, in order to eliminate the crosstalk signal in u₂(n) from TX2 so as to make the crosstalk signal in RX1 be zero as the zero crosstalk of r₁(n)=r₂(n) is satisfied, the equation could be re-organized as equation 14.

c₁₁(n)⊗q₂(n)+c₂₁(n)=0⇒c₂₁+c₁₁q₂=0 equation 14

In equation 13, in order to eliminate the crosstalk signal in u1(n) from TX1 so as to make the crosstalk signal in RX2 be zero as the zero crosstalk of r₂(n)=r₂(n) is satisfied, the equation could be re-organized as equation 15.

c₁₂(n)+c₂₂(n)⊗q₁(n)=0⇒c₁₂+c₂₂q₁=0 equation 15

In equation 14 and 15, c₁₁ and c₂₂ are the convolution matrix of c₁₁(n) c₂₂(n), c₂₁ c₁₂ are the crosstalk response vector of c₂₁(n) c₁₂(n), and q₁ q₂ are the only crosstalk canceling factor of q₁(n) q₂(n) pre-compensation vector.

However, in order to obtain the pre-compensation vector of the pre-compensation parameters of the transmitting end, the crosstalk response parameter of the transmitting end of the matrix C could be estimated by the least square technique as previously described, and thus the matrix C could be derived. After performing an inverse matrix operation on equation 14 and an inverse matrix operation on equation 15, q₁ and q₂ could be derived as equation 16 and equation 17.

q₂=−(C₁₁^{H}C₁₁)⁻¹C₁₁^{H}c₂₁ equation 16

q₁=−(C₂₂^{H}C₂₂)⁻¹C₂₂^{H}c₁₂ equation 17

In equations 16, q₂ is a pre-compensation parameter for cancelling m=2 crosstalk signal within 1=1, and q₁ is a pre-compensation parameter for cancelling m=1 crosstalk signal within 1=2.

However, since the above-described suppression of the crosstalk factor is only performed by using the pre-compensation vector q₁(n) q₂(n) for eliminating the crosstalk factor, the original main signal strength has been weakened so that additional pre-compensation processing is required for maintaining the main signal strength in order for the pre-compensation vector for the crosstalk of the transmitter be fully estimated. Therefore, based on the architecture of FIG. 9, the crosstalk problem at the transmitting end should be solved and at the same time the main signal strength could be maintained. Before the transmitting end would experience the crosstalk, the compensation parameter is added in advance in order to eliminate the upcoming crosstalk response of the transmitting end. By maintaining the original signal strength, the pre-compensated transmitting signal of the TX1 original signal can be expressed by equation 18.

TX_{p,1}: u_{p,1}(n)=q₃(n)⊗u₁(n)+q₂(n)⊗u₂(n) equation 18

The pre-compensated transmitting signal of the TX2 original signal could be expressed as equation 19.

TX_{p,2}: u_{p,2}(n)=q₄(n)⊗u₂(n)+q₁(n)⊗u₁(n) equation 19

By replacing u₁(n) of equation 18 with u_{p,1}(n), it represents the to be received signal r₁(n) after the signal in Tx1 has been compensated by the pre-compensation parameter as shown in m equation 20.

$$\begin{matrix}{r}_{1} ( n ) = {c}_{11} ( n ) ⊗ {u}_{p , 1} ( n ) + {c}_{21} ( n ) ⊗ {u}_{p , 2} ( n ) \\ = {c}_{11} ( n ) ⊗ \{ {q}_{3} ( n ) ⊗ {u}_{1} ( n ) + {q}_{2} ( n ) ⊗ {u}_{2} ( n ) \} + \\ {c}_{21} ( n ) ⊗ \{ {q}_{4} ( n ) ⊗ {u}_{2} ( n ) + {q}_{1} ( n ) ⊗ {u}_{1} ( n ) \}\end{matrix} \qquad equation 20$$

Equation 20 could be expanded to derived equation 21.

$${r}_{1} ( n ) = \{ {c}_{11} ( n ) ⊗ {q}_{3} ( n ) + {c}_{21} ( n ) ⊗ {q}_{1} ( n ) \} ⊗ {u}_{1} ( n ) \\ ⇑ ≡ δ ( n ) + \\ \{ {c}_{11} ( n ) ⊗ {q}_{2} ( n ) + {c}_{21} ( n ) ⊗ {q}_{4} ( n ) \} ⊗ {u}_{2} ( n ) \\ ⇑ ≡ 0 \qquad equation 21$$

By replacing u₂(n) of equation 3 with u_{p,2}(n) of equation 19, it represents i the to be received signal r₂(n) after the signal in Tx2 has been compensated by the pre-compensation parameter as shown in equation 22.

$$\begin{matrix}{r}_{2} ( n ) = {c}_{22} ( n ) ⊗ {u}_{p 2} ( n ) + {c}_{12} ( n ) ⊗ {u}_{p 1} ( n ) \\ = {c}_{22} ( n ) ⊗ \{ {q}_{4} ( n ) ⊗ {u}_{2} ( n ) + {q}_{1} ( n ) ⊗ {u}_{1} ( n ) \} + \\ {c}_{12} ( n ) ⊗ \{ {q}_{3} ( n ) ⊗ {u}_{1} ( n ) + {q}_{2} ( n ) ⊗ {u}_{2} ( n ) \}\end{matrix} \qquad equation 22$$

Equation 22 could be expanded to derive equation 23.

$${r}_{2} ( n ) = \{ {c}_{22} ( n ) ⊗ {q}_{1} ( n ) + {c}_{12} ( n ) ⊗ {q}_{3} ( n ) \} ⊗ {u}_{1} ( n ) \\ ⇑ ≡ 0 + \\ \{ {c}_{22} ( n ) ⊗ {q}_{4} ( n ) + {c}_{12} ( n ) ⊗ {q}_{2} ( n ) \} ⊗ {u}_{2} ( n ) \\ ⇑ ≡ δ ( n ) \qquad equation 23$$

For equation 21, in order for RX1 to receive the signal only from TX1 and set it to 1, and eliminate the crosstalk signal from TX2 in RX1 and make it 0 thus satisfying the zero crosstalk purpose of r2(n)≈u2(n), the above equation can be re-organized as equation 24.

$$\{ \begin{matrix}{c}_{11} ( n ) ⊗ {q}_{3} ( n ) + {c}_{21} ( n ) ⊗ {q}_{1} ( n ) = δ ( n ) \\ {c}_{11} ( n ) ⊗ {q}_{2} ( n ) + {c}_{21} ( n ) ⊗ {q}_{4} ( n ) = 0\end{matrix} ⇒ \{ \begin{matrix}{C}_{11} {\underline{q}}_{3} + {C}_{21} {\underline{q}}_{1} = \underline{e} \\ {C}_{11} {\underline{q}}_{2} + {C}_{21} {\underline{q}}_{4} = 0\end{matrix} \qquad equation 24$$

For equation 23, in order for RX2 to receive the signal only from TX2 and set it to 1, and eliminate the crosstalk signal from TX1 in RX2 and make it 0 thus satisfying the zero crosstalk purpose of r1(n)≈u1(n), the above equation can be re-organized as equation 25.

$$\{ \begin{matrix}{c}_{12} ( n ) ⊗ {q}_{3} ( n ) + {c}_{22} ( n ) ⊗ {q}_{1} ( n ) = 0 \\ {c}_{12} ( n ) ⊗ {q}_{2} ( n ) + {c}_{22} ( n ) ⊗ {q}_{4} ( n ) = δ ( n )\end{matrix} ⇒ \{ \begin{matrix}{C}_{12} {\underline{q}}_{3} + {C}_{22} {\underline{q}}_{1} = 0 \\ {C}_{12} {\underline{q}}_{2} + {C}_{22} {\underline{q}}_{4} = \underline{e}\end{matrix} \qquad equation 25$$

In equations 24 and 25, c₁₁ c₂₁ c₁₂ c₂₂ are the convolution matrix of c₁₁(n) c₂₁(n) c₁₂(n) c₂₂(n), q₁ q₂ q₃ q₄ is the response vector of q₁(n) q₂(n) q₃(n) q₄(n), and e=[1 0^{T}]^{T} is a vector with the first element being 1 and the other elements being 0. After re-arranging equations 24 and 25, equations 26 and 27 could be respectively derived.

$$\begin{matrix}[ \begin{matrix}{C}_{11} & {C}_{21} \\ {C}_{12} & {C}_{22}\end{matrix} ] [ \begin{matrix}{\underline{q}}_{3} \\ {\underline{q}}_{1}\end{matrix} ] = [ \begin{matrix}\underline{e} \\ \underline{0}\end{matrix} ] & equation 26 \\ [ \begin{matrix}{C}_{11} & {C}_{21} \\ {C}_{12} & {C}_{22}\end{matrix} ] [ \begin{matrix}{\underline{q}}_{2} \\ {\underline{q}}_{1}\end{matrix} ] = [ \begin{matrix}\underline{0} \\ \underline{e}\end{matrix} ] \\ where C = [ \begin{matrix}{C}_{11} & {C}_{21} \\ {C}_{12} & {C}_{22}\end{matrix} ] & equation 27\end{matrix}$$

In order to obtain the response vector of the pre-compensation parameters of the transmitting end, the above described LS technique could be used to estimate the crosstalk response parameters of the matrix C. Since matrix C is already a known parameter, after performing an inverse matrix operation of equation 26 and an inverse matrix operation of equation 27, equations 28 and 29 could be respectively derived.

$$\begin{matrix}[ \begin{matrix}{\underline{q}}_{3} \\ {\underline{q}}_{1}\end{matrix} ] = {( {C}^{H} C )}^{- 1} {C}^{H} [ \begin{matrix}\underline{e} \\ \underline{0}\end{matrix} ] & equation 28 \\ [ \begin{matrix}{\underline{q}}_{2} \\ {\underline{q}}_{4}\end{matrix} ] = {( {C}^{H} C )}^{- 1} {C}^{H} [ \begin{matrix}\underline{0} \\ \underline{e}\end{matrix} ] & equation 29\end{matrix}$$

Accordingly, the transmitter pre-compensation vector of the transmitting end could be obtained through equations 28 and 29 so as to complete the pre-compensation procedure for eliminating the crosstalk response in each channels of the transmitter.

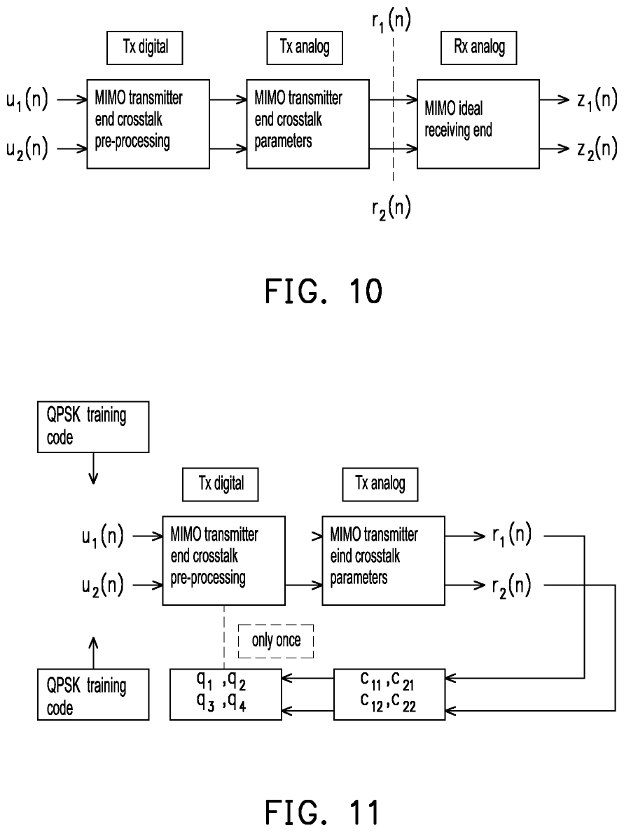

Based on the disclosure above, a crosstalk estimation system is proposed for transmitter-side crosstalk calibration. The system block diagram could be represented as FIG. 10 illustrates a 2×2 MIMO transmitter architecture according to one of the exemplary embodiments of the disclosure. The system includes a TX digital block which performs the above described crosstalk pre-processing, a TX analog block containing crosstalk parameters, and an RX analog block which is a receiver assumed to be in an ideal state.

The system of FIG. 10 is further expanded upon as shown in FIG. 11. First, the (LS) method is used by combining the transmitting end and the receiving end to simultaneously transmit and receive the estimation by using the same frequency. Next, a known QPSK training code could be used as the reference signal U₁(n), U₂(n). The above described inverse matrix and the subsequent convolution could be performed with the receiving signal R₁(n)′R₂(n) to re-arrange the matrix so as to estimate crosstalk response c₁₁ c₂₁ c₁₂ c₂₂ of the transmitting. Also, as previously described, the estimated crosstalk response c₁₁ c₂₁ c₁₂ c₂₂ of the transmitter could be arranged into C through a matrix and then converted by an inverse matrix operation to estimate the pre-compensation parameter q₁ q₂ q₃ q₄. The purpose of such is to make RX1 only receive the signal from TX1, but not the coupling interference signal from TX2. At the same time, RX2 would receive the signal from TX2 without including the coupling interference signal from TX1, which satisfies equations 24 and 25.

After the cross-talk response c₁₁ c₂₁ c₁₂ c₂₂ and the pre-compensation vector q₁ q₂ q₃ q₄ are estimated, single carrier or multi-carrier signal to be transmitted could be added to the pre-compensation vector so that RX1 only receives the signal from TX1, while RX2 only receives the signal from TX2. The system is capable of obtaining the crosstalk response and the pre-compensation vector through only one estimation which may occur when the power is turned on, and then the estimated parameters could be used continuously to complete the pre-compensation transmission and reception for the signal to be tested. The overall process has been described in FIG. 6.

FIG. 12 illustrates a schematic diagram of a joint estimation process for performing the crosstalk adjustment of a MIMO transmitter according to one of the exemplary embodiments of the disclosure. Steps S1201, S1202, and S1203 are performed based on a joint estimation method of TX1, TX2 and RX1, RX2 while assuming the above described 2×2 MIMO system. In step S1201, both TX1 and TX2 would each transmit different known QPSK training codes. In step S1202, c₁₁, c₂₁, c₁₂, and c₂₂ are estimated. In step S1203, RX1 would receive the QPSK training code from TX1 and RX2 would receive the QPSK training code from TX2. In step S1204, the crosstalk factor of the transmitting end would be estimated. In step S1205, the compensation parameters q₁, q₂, q₃, q₄ would be estimated.

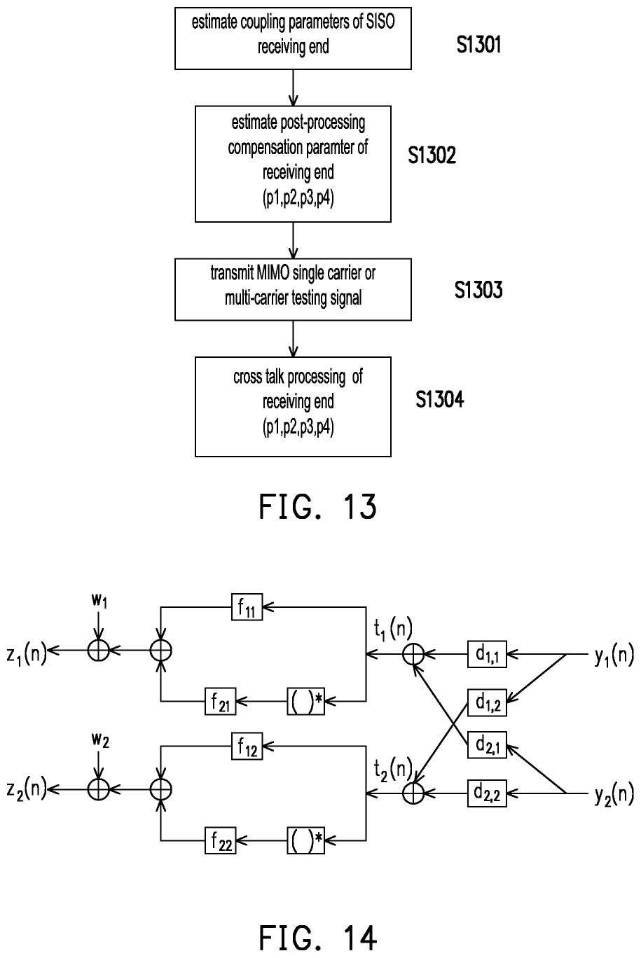

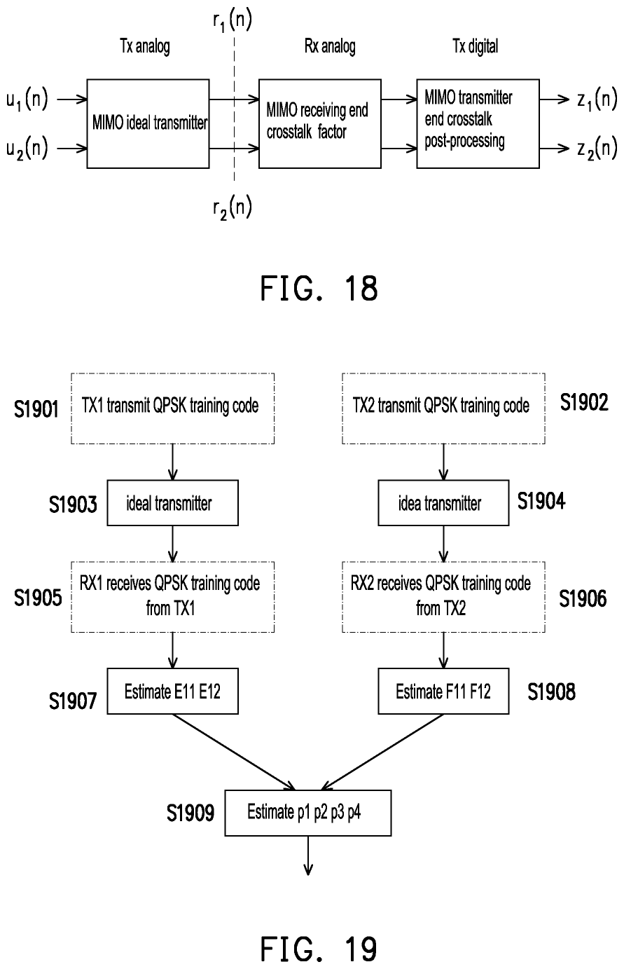

Next, in order for the disclosure to further describe the method of configuring the wideband MIMO receiver and the structure of the wideband MIMO receiver, the disclosure provides several exemplary embodiments as shown in FIG. 13˜FIG. 19. FIG. 13 is a flow chart which describes the steps of calculating the post-processing parameters for cancelling crosstalk according to one of the exemplary embodiments of the disclosure. In step S1301, a SISO based measurement would be performed to estimate the post-processing parameters P₁ P₂ P₃ P₄ by switching among channels of the transmitter such as by switching between TX1 and TX2 as well as by switching between RX1 and RX2. For example, TX1 and RX1 could be connected while other paths are isolated from the connection between TX1 and RX1. Next, TX1 and RX2 could be connected while other paths are isolated. Next, TX2 and RX1 could be connected while other paths are isolated. Next, TX2 and RX2 could be connected while other paths are isolated, and so forth. In step S1302, post-processing parameters P₁ P₂ P₃ P₄ would be obtained based on the measurement of step S1301. In step S1303, a MIMO based measurement would be performed in response to transmitting MIMO single carrier or multi-carrier test signal to obtain sets of crosstalk parameters. In step S1304, based on the estimated the post-processing parameters P₁ P₂ P₃ P₄ and sets of crosstalk parameters, the post-processing parameters P₁ P₂ P₃ P₄ could be derived.

FIG. 14 is a system block diagram of a MIMO receiver having IQI and coupling distortion. The disclosure will provide a mechanism to estimate and compensate for the wideband crosstalk factor of the MIMO receivers and the post-processing parameters of the MIMO receiver in this section. The wideband crosstalk factor at the receiving end refers to a scenario in which a crosstalk factor is stored when the multi-channel radio frequency circuit is fabricated at the receiving end before the frequency-transmitted signal is received by the radio frequency. Such phenomenon could be more pronounced on a PC board on a RF chip. The channel receiving signals may interfere with each other, causing crosstalk between multiple receiving ends as well signal distortions to affect the performance of multiple receiving signals. After the wideband crosstalk of the receiving end is resolved, and the crosstalk factor of the receiving end could be estimated and subsequently compensated with a post-processing procedure.

However, when the signal is transmitted through the multi-input and wideband system having crosstalk, a signal could be received at the receiving end and be corrupted because of cross channel coupling or crosstalk effect before the signal receives RF down-conversion, and then the down-converted received signal could be carried along with the receiver's broadband RF imperfect factor (IQ Imbalance, IQI) of the receiver. Such phenomenon is shown in the block diagram of FIG. 14.

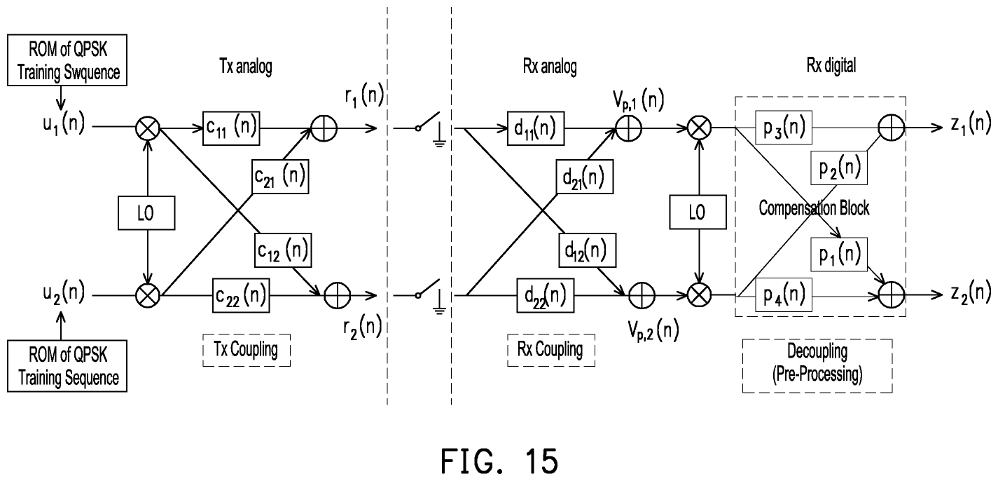

However, the above describe problem could be resolved. FIG. 15 shows a MIMO receiver having crosstalk post-compensation according to one of the exemplary embodiments of the disclosure. The disclosure would provide an equivalent model which indicates the main signal as ‘1’ and the coupled signal as ‘m’, and the signal transmitted by the first channel to the receiving end having crosstalk is shown in equation 101.

$${t}_{l} ( n ) = {y}_{l} ( n ) + {\sum }_{m = 1 , m \neq l}^{M} {d}_{m l} ( n ) ⊗ {y}_{m} ( n ) \qquad equation 101$$

In addition, the signal t₁ (n) which is distorted by crosstalk of the receiving end is down-converted and thus received by the wide-band IQI factor of the receiving end. The received signal z₁ (n) could be obtained as shown in equation 101.

z₁(n)=f₁ₗ(n)⊗tₗ(n)+f₂ₗ(n)⊗t*ₗ(n)+wₗ(n) equation 101

Wherein, in the equation 101, dₘₗ(n) represents the filter response value of the m^{th} antenna to the crosstalk of the l^{th} antenna receiving end, and in the equation 102, wₗ(n) represents the noise of the l^{th} antenna. However, the disclosure may assume that the broadband RF imperfection factor has been adjusted, and then the multi-input wideband system receiver broadband crosstalk factor response and its post-processing crosstalk adjustment method would be performed as provided. For the simplicity of disclosure, a 2×2 MIMO system is to be assumed.

In the transmitting end, U₁(n) U₂(n) are assumed to be the original transmission signal without crosstalk. As such signal enters the TX analog section, the crosstalk of the transmitting end could be obtained from the multipath of r₁(n) and r₂(n). When entering the RX analog section of the receiver, crosstalk at the receiving end would occurs. V_{p,1}, (n) and V_{P,2}(n) respectively would represent the receive signals having crosstalk, and Z1(n) and Z2(n) would represent the signals output from the RX digital section and having been compensated by the post-process compensation parameter P₁(n) P₂(n) P₃(n) P₄(n). If the post-processing compensation parameter P₁(n) P₂(n) P₃(n) P₄(n) could be be accurately estimated, the Z1(n) and Z2(n) would be able to output signals having to have no crosstalk out of the receiving end.

Thus, a mathematical modelling method for estimating the crosstalk response at the receiving end of this 2×2 MIMO wideband receiving end system is to be provided. The receiving end crosstalk response e₁₁ e₁₂ f₂₁ f₂₂ could be derived from the mathematical model of the receiving end post processing parameter P₁ P₂ P₃ P₄.

Since the transmitting end and the receiving end both contain a crosstalk factor on the transceiver of the MIMO transceiver system, in order to estimate the coupling amount of the receiving end and subsequently eliminate the crosstalk, it could be helpful to isolate and simplify the remaining signals through several conditions. First, the signal is to be transmitted twice, first from TX1 and second from TX2 signal. A switch is utilized before the receiving end to performing switching between a connection state and a grounding state of the transmitted signal so as to interface with RX1 and RX2 of the receiver. The permutation of the 2×2 MIMO transceiver is shown in Table 1 below.

TABLE 1

| 2 × 2 MIMO with 4 | TX1 | TX2 |
|---|---|---|
| sets of conditions for | (1 represents on and 0 | (1 represents on and 0 |
| estimating crosstalk | represents off) | represents off) |
| RX1 | TX1 = 1 \grave{ } TX2 = 0 | TX1 = 0 \grave{ } TX2 = 1 |
| (1 represents on and 0 | RX1 = 1 \grave{ } RX2 = 0 | RX1 = 1 \grave{ } RX2 = 0 |
| represents off) | First set of conditions | Third set of conditions |
| RX2 | TX1 = 1 \grave{ } TX2 = 0 | TX1 = 0 \grave{ } TX2 = 1 |
| (1 represents on and 0 | RX1 = 0 \grave{ } RX2 = 1 | RX1 = 0 \grave{ } RX2 = 1 |
| represents off) | Second set of conditions | Forth set of conditions |

In order to estimate the crosstalk factor at the receiving end of the broadband MIMO system, the QPSK signal is to be used as the training code. The LS method could be used to estimate the broadband crosstalk factor at the receiving end. The disclosure would also provide a procedure to estimate the post-processing vector at the receiving end, to solve the crosstalk factor at the receiving end of the MIMO transceiver system, and to achieve the high-quality communication requirements of the wide-band MIMO system in the following section.

First, when estimating the crosstalk factor d₁₁(n), d₂₁(n), d₁₂(n), d₂₂(n) at the receiving end, there is no pre-compensation and post-processing for the crosstalk factor between the transmitting end and the receiving end before and after the transmitting end, and thus q₁(n)=q₂(n)=q₃(n)=q₄(n) and p₁(n)=p₂(n)=p₃(n)=p₄(n)=0. Therefore, in the first set of conditions, only the TX1 transmit signal with crosstalk through the transmitting end, and only RX1 receives the received signal before being interfered by the crosstalk of the receive end (TX1=QPSK, TX2=0, RX1=1, RX2=0). Thus, in the scenario where TX1 receives the main signal and TX2 receives the crosstalk, the received signal in RX1 after transmission of TX1 could be expressed as by equation 103.

z₁(n)=u₁(n)⊗c₁₁(n)⊗d₁₁(n) equation 103

Based on equation 103, the convolution of crosstalk c₁₁(n) and d₁₁(n) received at the receiving end could be represented as a new crosstalk variable a shown in equation 104.

z₁(n)=u₁(n)⊗e₁₁(n)⇒z₁=U₁e₁₁ equation 104

However, for the first set of conditions, in the scenario where TX2 transmits the main signal and TX1 transmits the crosstalk signal end, the receiving signal at RX2 after the TX2 transmission could be expressed as equation 105.

z₂(n)=u₁(n)⊗c₁₁(n)⊗d₁₂(n) equation 105

According to equation 105, the crosstalk c₁₁(n) and d₁₂(n) received at the receiving end can be convolved and renamed to a new crosstalk variable ei2(n), as shown in the equation 106.

z₂(n)=u₁(n)⊗e₁₂(n)⇒z₂=U₁e₁₂ equation 106

Next, by inverting the matrix of equation 104 and equation 106, the new crosstalk parameters e₁₁ and d₁₂ could be obtained from the first set of conditions, as expressed by the following equation (4.7).

$$\{ \begin{matrix}{\underline{e}}_{11} = {U}_{1}^{+} {\underline{z}}_{1} \\ {\underline{e}}_{12} = {U}_{1}^{+} {\underline{z}}_{2}\end{matrix} , obtain {\underline{e}}_{11} ` {\underline{e}}_{12} \qquad equation 107$$

Next, in the second set of conditions, only the TX1 would transmit signal with crosstalk through the transmit end, and only RX2 would receive crosstalk signal before the receiving end (TX1=QPSK, TX2=0, RX1=0, RX2=1). At this time, in the scenario where TX1 transmits the main signal and TX2 transmits the crosstalk signal end, the RX1 would receive signal after the signal transmission from TX1 transmission which could be expressed as equation 108.

z₁(n)=u₁(n)⊗c₁₂(n)⊗d₂₁(n) equation 108

Among them, according to the equation 108, the crosstalk c₁₂ and d₁₂ received at the receiving end can be convolved and renamed as a new crosstalk variable, as shown in equation 109.

z₁(n)=u₁(n)⊗e₂₁(n)⇒z₁=U₁e₂₁ equation 109

However, for the second group of conditions, in the scenario where TX2 transmits the main signal and TX1 transmits the crosstalk signal end, the receiving signal transmitted by TX2 and received by RX2 could be expressed as equation 110.

z₂(n)=u₁(n)⊗c₁₂(n)⊗d₂₂(n) equation 110

According to equation 110, the crosstalk c₁₂(n) and d₂₂(n) received at the receiving end can be convolved and renamed to a new crosstalk variable, as shown in the following equation 111.

z₂(n)=u₁(n)⊗e₂₂(n)⇒z₂=U₁e₂₂ equation 111

Subsequently, the equations 109 and 111 could be inverted, and the new crosstalk parameter could be obtained from the second set of conditions, as expressed by the following equation 112.

$$\{ \begin{matrix}{\underline{e}}_{21} = {U}_{1}^{+} {\underline{z}}_{1} \\ {\underline{e}}_{22} = {U}_{1}^{+} {\underline{z}}_{2}\end{matrix} , obtain {\underline{e}}_{21} ` {\underline{e}}_{22} \qquad equation 112$$

Then, in the third set of conditions, only the TX2 transmit signal with crosstalk through the transmit end and only RX1 would receive the signal before the receive end with crosstalk (TX1=0, TX2=QPSK, RX1=1, RX2=0). In the scenario where the main signal is transmitted from TX1 and the crosstalk is transmitted from TX2, the received signal z₁(n) from RX1 after being transmitted by the TX1 can be expressed as equation 113.

z₁(n)=u₂(n)⊗c₂₁(n)⊗d₁₁(n) equation 113

According to equation 113, The convolution of the crosstalk c₂₁(n) and d₁₁(n) that can be received at the receiving end and can be renamed to a new crosstalk variable according to equation 114.

z₁(n)=u₂(n)⊗f₁₁(n)⇒z₁=U₂f₁₁ equation 114

However, for the third group of conditions, in the scenario where TX2 transmits the main signal and TX1 transmits the crosstalk signal, the receiving signal of RX2 transmitted by TX2 can be expressed as equation 115.

z₂(n)=u₂(n)⊗c₂₁(n)⊗d₁₂(n) equation 115

Then, according to the above equation 115, the crosstalk c₂₁(n) and d₁₂(n) received at the receiving end can be convolved and renamed as a new crosstalk variable, as shown in the following equation 116.

z₂(n)=u₂(n)⊗f₁₂(n)⇒z₂=U₂f₁₂ equation 116

Subsequently, the equations 114 and 116 could be inverted, and the new crosstalk parameters could be obtained from the third set of conditions, as expressed by the following equation 117.

$$\{ \begin{matrix}{\underline{f}}_{21} = {U}_{2}^{+} {\underline{z}}_{1} \\ {\underline{f}}_{22} = {U}_{2}^{+} {\underline{z}}_{2}\end{matrix} , obtain {\underline{f}}_{11} ` {\underline{f}}_{12} \qquad equation 117$$

Finally, in the fourth set of conditions, only the TX2 transmit signal with crosstalk through the transmit end and only RX2 would receive signal before the crosstalk of the receive end (TX1=0, TX2=QPSK, RX1=0, RX2=1). In the scenario where TX1 transmits the main signal and the TX2 transmits the crosstalk signal, the signal received by RX1 and transmitted by the TX1 could be expressed as equation 118.

z₁(n)=u₂(n)⊗c₂₂(n)⊗d₂₁(n) equation 118

Then, according to the above equation 118, the convolution of the crosstalk c₂₂(n) and d₂₁(n) received at the receiving end can be renamed to a new crosstalk variable f₂₁ as equation 119.

z₁(n)=u₂(n)⊗f₂₁(n)⇒z₁=U₂f₂₁ equation 119

However, for the fourth set of conditions, in the scenario where TX2 transmits the main signal and TX1 transmits the crosstalk signal end, the signal z₂(n) received by RX2 receiving signal after being transmitted by TX2 can be expressed as equation 120.

z₂(n)=u₂(n)⊗c₂₂(n)⊗d₂₂(n) equation 120

Then, according to the above equation 120, the crosstalk c₂₂(n) and d₂₂(n) received at the receiving end can be convolved and renamed to a new crosstalk variable f₂₂(n), as shown in the following equation 121.

z₂(n)=u₂(n)⊗f₂₂(n)⇒z₂=U₂f₂₂ equation 121

By performing a reverse matrix operation of equation 119 and 121, based on the fourth set of conditions, a new crosstalk variable f₂₁ and f₂₂ could be obtained as shown in equation 122.

$$\{ \begin{matrix}{\underline{f}}_{21} = {U}_{2}^{+} {\underline{z}}_{1} \\ {\underline{f}}_{22} = {U}_{2}^{+} {\underline{z}}_{2}\end{matrix} , obtain {\underline{f}}_{21} ' {\underline{f}}_{22} \qquad equation 122$$

Among them, in the above four sets of conditions in equations 107, 112, 117 and 122, both z₁ and z₂ are vector representations of z₁ and z₂, and U₁ and U₂ are convolution matrices of u₁(n) and u₂(n).

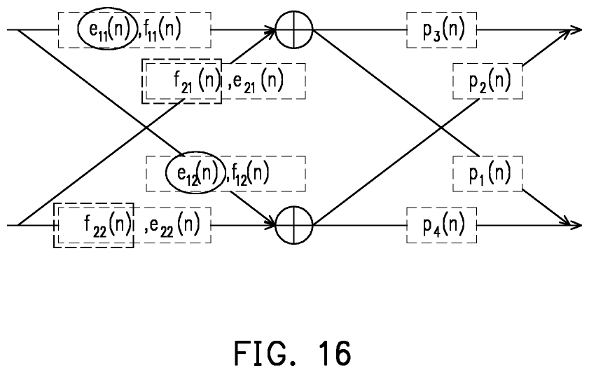

When estimating the crosstalk response at the receiving end, the QPSK modulation signal could be used as the known training code of the transmitting end u₁(n) or u₂(n). By using a switch, the crosstalk or signal entering the receiving end could be controlled and thus forming a new crosstalk response at the receiving end and its post-processing compensation architecture. FIG. 16 is a conceptual diagram showing the relationship between crosstalk parameters and post-processing parameters according to one of the exemplary embodiments of the disclosure. However, according to the second set of conditions and the third set of conditions, after signal from TX1/TX2 having crosstalk is received by RX2/RX1, the signal will be coupled to both the transmitting end and the receiving end. Therefore, when the first set of conditions and the fourth set of conditions are satisfied, according to the above equations 107 and 122, the crosstalk response parameter \vec{e}₁₁ e₁₂ f₂₁ f₂₂ could be estimated by the LS method. The post-processing compensation parameter p₁ p₂ p₃ p₄ of the receiving end by using algorithms provided in the next section of the disclosure. In order to solve the problem of multipath crosstalk at the receiving end, the post-processing vectors p₁(n) p₂(n) p₃(n) p₄(n) could be used as shown in FIG. 15 to complete the crosstalk response suppression interference at the receiving end. However, estimating the compensation vectors p₁(n) p₂(n) p₃(n) p₄(n) at the receiving end, since both the transmitting end and the receiving end contain a crosstalk factor on the transceiver of the MIMO system, there is no pre-compensation for the transmitting end before the transmitting end. Thus q₁(n)=q₂(n)=q₃(n)=q₄(n)=0. Therefore, the TX1 RF signal transmitted after the crosstalk response of the transmitting end can be expressed as equation 123.

TX₁:r₁(n)=c₁₁(n)⊗u₁(n)+c₂₁(n)⊗u₂(n) equation 123

The TX2 RF signal r2(n) after the transmitter crosstalk response is transmitted can be expressed as equation 124.

TX₂: r₂(n)=c₁₂(n)⊗u₁(n)+c₂₂(n)⊗u₂(n) equation 124

The received signal v_{p,1}(n) after r₁(n) receives crosstalk, the response of the receiving end is expressed as equation 125.

v_{p,1}(n)=r₁(n)⊗d₁₁(n)+r₂(n)⊗d₂₁(n) equation 125

The received signal v_{p,2}(n) after r₂(n) receives crosstalk, the response of the receiving end is expressed as equation 126.

v_{p,2}(n)=r₁(n)⊗d₁₂(n)+r₂(n)⊗d₂₂(n) equation 126

As seen from the above figure that when the analog signal receives crosstalk by the receiving end and enters the digital end, and the analog signal is processed by the receiving end to obtain the receiving signal in RX1. The equation can be expressed as equation 127.

z₁(n)=p₃(n)⊗v_{p,1}(n)+p₂(n)⊗v_{p,2}(n) equation 127

At the same time, when the analog signal vp,2(n) after receiving crosstalk of the receiving end enters the digital domain and performs the post-processing compensation of the receiving end to obtain the receiving signal z₂(n) through RX2, the equation can be expressed as equation 128.

z₂(n)=p₁(n)⊗v_{p,1}(n)+p₄(n)⊗v_{p,2}(n) equation 128

However, according to the above description, in order to eliminate the crosstalk at the receiving end, it could be helpful to isolate and simplify the remaining signals, thereby forming the above four sets of conditions. In the first set of conditions, only the TX1 transmit signal with crosstalk through the transmitting end, and only RX1 would receive signal before receiving crosstalk at the receiving end (TX1=QPSK, TX2=0, RX1=1, RX2=0). At this time, since the RF signal and the RF signal transmitted by the crosstalk response of the TX1 and TX2 transmitters respectively have only the signal from U₁(n) at the TX1, the part of the signal can be obtained from the equation 123 and 124 and expressed as equations 129 and 130 below.

TX₁:r₁(n)=c₁₁(n)⊗u₁(n) equation 129

TX₂: r₂(n)=c₁₂(n)⊗u₁(n) equation 130

Then, the crosstalk response is input to the receiving end, and the equations 129 and 130 are substituted into the equation 125 to obtain the signal v_{p,1}(n). Next, the convolution of c₁₁(n) and d₁₁(n) is renamed to the new crosstalk variable e₁₁(n), and the convolution is performed between c₁₁(n) and d₁₁(n). The new crosstalk variable e₂₁(n) is as shown in equation 131.

$$\begin{matrix}{v}_{p , 1} ( n ) = & \{ {u}_{1} ( n ) ⊗ {c}_{11} ( n ) \} ⊗ {d}_{11} ( n ) + \\ & \{ {u}_{1} ( n ) ⊗ {c}_{12} ( n ) \} ⊗ {d}_{21} ( n ) \\ = & {u}_{1} ( n ) ⊗ {e}_{11} ( n ) + {u}_{1} ( n ) ⊗ {e}_{21} ( n )\end{matrix} \qquad equation 131$$

However, in the first set of conditions, only the signal r₁(n) is input through the switch before receiving the crosstalk at the receiving end, so that the v_{p,1}(n) signal of the RX1 only contains the r₁(n) RF signal, such as equation 132.

$$\begin{matrix}{v}_{p , 1} ( n ) = \{ {u}_{1} ( n ) ⊗ {c}_{11} ( n ) \} ⊗ {d}_{11} ( n ) \\ = {u}_{1} ( n ) ⊗ {e}_{11} ( n )\end{matrix} \qquad equation 132$$

At the same time, after entering the crosstalk response of the receiving end, the equations 129 and 130 are substituted into the equation 126 to obtain the v_{p,2}(n) signal. The convolution of c₁₁ (n) and d₁₂ (n) is renamed to the new crosstalk variable e₁₂(n), and c₁₂ is obtained. The convolution with d₂₂(n) is renamed to the new crosstalk variable e₂₂(n) as in equation 133.

$$\begin{matrix}{v}_{p , 2} ( n ) = & \{ {u}_{1} ( n ) ⊗ {c}_{11} ( n ) \} ⊗ {d}_{12} ( n ) + \\ & \{ {u}_{1} ( n ) ⊗ {c}_{12} ( n ) \} ⊗ {d}_{22} ( n ) \\ = & {u}_{1} ( n ) ⊗ {e}_{12} ( n ) + {u}_{1} ( n ) ⊗ {e}_{22} ( n )\end{matrix} \qquad equation 133$$

According to the first set of conditions, only the signal r₁(n) is input through the switch before the crosstalk at the receiving end, and the v_{p,2}(n) signal of the RX2 only contains the crosstalk RF signal of r₁(n), as expressed in equation 134.

$$\begin{matrix}{v}_{p , 2} ( n ) = \{ {u}_{1} ( n ) ⊗ {c}_{11} ( n ) \} ⊗ {d}_{12} ( n ) \\ = {u}_{1} ( n ) ⊗ {e}_{12} ( n )\end{matrix} \qquad equation 134$$

Subsequently, after entering the digital end processing, it is assumed that the post-processing parameter p₁(n) p₂(n) p₃(n) p₄(n) can counteract the signal of the crosstalk response of RX1 and the signal v_{p,1}(n) of the crosstalk response of RX2, so the equations 132 and 134 are substituted into the equation 127. RX1 receives the signal z₁(n) as shown in equation 135.

$${z}_{1} ( n ) = {p}_{3} ( n ) ⊗ \{ {u}_{1} ( n ) ⊗ {e}_{11} ( n ) \} + {p}_{2} ( n ) ⊗ \{ {u}_{1} ( n ) ⊗ {e}_{12} ( n ) \} \qquad equation 135$$

The equation 135 could be rearranged to the equation that the TX1 transmits the signal u₁(n) in the RX1 reception signal z₁(n), and then the processing vector suppresses the received crosstalk response, as shown in the following equation 136.

$${z}_{1} ( n ) = {u}_{1} ( n ) ⊗ \{ {p}_{3} ( n ) ⊗ {e}_{11} ( n ) \} + {u}_{1} ( n ) ⊗ \{ {p}_{2} ( n ) ⊗ {e}_{12} ( n ) \} \qquad equation 136$$

After expanding the equations 132, 134 and substitute them into equation 128, Z₂(n) could be obtained at RX2 as expressed in equation 137.

$${z}_{2} ( n ) = {p}_{1} ( n ) ⊗ \{ {u}_{1} ( n ) ⊗ {e}_{11} ( n ) \} + {p}_{4} ( n ) ⊗ \{ {u}_{1} ( n ) ⊗ {e}_{12} ( n ) \} \qquad equation 137$$

After rearranging equation 137 as transmitting signal u₁(n) for TX1 in RX2 receive signal z₂(n), the subsequent processing vector suppresses the equation for receiving the crosstalk response as shown in equation 138.

$${z}_{2} ( n ) = {u}_{1} ( n ) ⊗ \{ {p}_{1} ( n ) ⊗ {e}_{11} ( n ) \} + {u}_{1} ( n ) ⊗ \{ {p}_{4} ( n ) ⊗ {e}_{12} ( n ) \} \qquad equation 138$$

In the first set of conditions, the TX1 transmission signal U₁(n) is the main signal. According to the above equations 136 and 138, it can be known that the equation 136 RX1 receiving signal z₁(n) maintains the original signal reception (equation And=1), at the same time, the RX2 receiving signal z₂(n) in the equation 138 formula is suppressed (the equation and =0). Therefore, the effective set equation of the first set of conditions can be unified, as shown in the following equation 139.

$$\{ \begin{matrix}{p}_{3} ( n ) ⊗ {e}_{11} ( n ) + {p}_{2} ( n ) ⊗ {e}_{12} ( n ) = δ ( n ) \\ {p}_{1} ( n ) ⊗ {e}_{11} ( n ) + {p}_{4} ( n ) ⊗ {e}_{12} ( n ) = 0 \end{matrix} . \qquad equation 139$$

Equation 139 can be expressed as a matrix form as equation 140.

$$\{ \begin{matrix}{\underline{E}}_{11} {\underline{p}}_{3} + {\underline{E}}_{12} {\underline{p}}_{2} = \underline{e} \\ {\underline{E}}_{11} {\underline{p}}_{1} + {\underline{E}}_{12} {\underline{p}}_{4} = \underline{0}\end{matrix} \qquad equation 140$$

In the second set of conditions, only the TX1 transmit signal with crosstalk through the transmit end, and only RX2 receives signal before receiving crosstalk of the receive end (TX1=QPSK, TX2=0, RX1=0, RX2=1). It can be found that since the second set of conditions is consistent with the conditions of the first set of conditions, only the signal u₁(n) from TX1 exists, so the RF signal r₁(n) and r₂(n) transmitted after the analog end crosstalk response is transmitted through TX1 and TX2 respectively. And the RF signal can be sequentially expressed as shown in equations 129 and 130.

Then, after entering the analog crosstalk receiving end, the equation 129 and the equation type are substituted into the equation type to obtain the v_{p,2}(n) signal of the second set of conditions, which only contains the u₁(n) signal of the TX1, so according to the equation 131 above, new crosstalk parameters e₁₁(n) and e₂₁(n) could be obtained as equation 141.

$$\begin{matrix}{v}_{p , 1} ( n ) = & \{ {u}_{1} ( n ) ⊗ {c}_{11} ( n ) \} ⊗ {d}_{11} ( n ) + \\ & \{ {u}_{1} ( n ) ⊗ {c}_{12} ( n ) \} ⊗ {d}_{21} ( n ) \\ = & {u}_{1} ( n ) ⊗ {e}_{11} ( n ) + {u}_{1} ( n ) ⊗ {e}_{21} ( n )\end{matrix} \qquad equation 141$$

However, in the second set of conditions, only the signal r₂(n) is input through the switch before receiving the crosstalk at the receiving end, so that the v_{p,1}(n) signal of the RX1 only contains the r₂(n) RF signal, such as equation 142.

$$\begin{matrix}{v}_{p , 1} ( n ) = \{ {u}_{1} ( n ) ⊗ {c}_{11} ( n ) \} ⊗ {d}_{21} ( n ) \\ = {u}_{1} ( n ) ⊗ {e}_{21} ( n )\end{matrix} \qquad equation 142$$

At the same time, after entering the crosstalk response of the receiving end, the equations 129 and 130 formulas are substituted into the equation 126 to obtain the signal V_{p,2}(n), and since it only contains the signal U₁(n) of TX1, according to the above equation 133, new crosstalk parameters e₁₂(n) and e₂₂(n) could be obtained and, as shown in equation 143.

$$\begin{matrix}{v}_{p , 2} ( n ) = & \{ {u}_{1} ( n ) ⊗ {c}_{11} ( n ) \} ⊗ {d}_{12} ( n ) + \\ & \{ {u}_{1} ( n ) ⊗ {c}_{12} ( n ) \} ⊗ {d}_{22} ( n ) \\ = & {u}_{1} ( n ) ⊗ {e}_{12} ( n ) + {u}_{1} ( n ) ⊗ {e}_{22} ( n )\end{matrix} \qquad equation 143$$

According to the second set of conditions, only the input signal r₂(n) is transmitted through the switch before the crosstalk is introduced at the receiving end, and the RX2 would only contain signal V_{p,2}(n) which contains the crosstalk RF signal of R₂(n), such as shown in equation 144.

$$\begin{matrix}{v}_{p , 2} ( n ) = \{ {u}_{1} ( n ) ⊗ {c}_{11} ( n ) \} ⊗ {d}_{22} ( n ) \\ = {u}_{1} ( n ) ⊗ {e}_{22} ( n )\end{matrix} \qquad equation 144$$

Subsequently, after entering the digital terminal, it is assumed that the post-processing parameters P₁(n) p₂(n) P₃(n) P₄(n) can counter the signal V_{p,1}(n) of the crosstalk response of RX1 and V_{P,2}(n) of the crosstalk response of RX2, so the equations of 142 and 144 could be substituted into equation 127, and thus the receiving signal Z₁(n) at RX1 could be obtained and expressed as equation 145.

$${z}_{1} ( n ) = {p}_{3} ( n ) ⊗ \{ {u}_{1} ( n ) ⊗ {e}_{21} ( n ) \} + {p}_{2} ( n ) ⊗ \{ {u}_{1} ( n ) ⊗ {e}_{22} ( n ) \} \qquad equation 145$$

The equation (4.45) can be rearranged into the equation for z₁(n) of RX1 corresponding to U₁(n) of the TX1 transmit signal, and then the processing vector suppresses the received crosstalk response, as shown in the following equation 146.

$${z}_{1} ( n ) = {u}_{1} ( n ) ⊗ \{ {p}_{3} ( n ) ⊗ {e}_{21} ( n ) \} + {u}_{1} ( n ) ⊗ \{ {p}_{2} ( n ) ⊗ {e}_{22} ( n ) \} \qquad equation 146$$

Substituting equations 142 and 144 into 148 would derive Z₂(n) at RX2 such as equation 147.

$${z}_{2} ( n ) = {p}_{1} ( n ) ⊗ \{ {u}_{1} ( n ) ⊗ {e}_{21} ( n ) \} + {p}_{4} ( n ) ⊗ \{ {u}_{1} ( n ) ⊗ {e}_{22} ( n ) \} \qquad equation 147$$

The equation 147 could be rearranged into Z₂(n) of RX2 corresponding to U₁(n) in TX1, and then the processing vector suppresses the received crosstalk response, as shown in the following equation 148.

$${z}_{2} ( n ) = {u}_{1} ( n ) ⊗ \{ {p}_{1} ( n ) ⊗ {e}_{21} ( n ) \} + {u}_{1} ( n ) ⊗ \{ {p}_{4} ( n ) ⊗ {e}_{22} ( n ) \} \qquad equation 148$$

Finally, in the second set of conditions, the u₁(n) of the TX1 transmit signal is the main signal. According to the above equations 136 and 148, it can be known that the RX1 receive signal z₁(n) of the equation 146 would need to maintain the original signal reception (equal and =1). At the same time, the RX2 receiving signal z₂(n) in equation 148 must be suppressed (the equation and =0). Therefore, the effective set equation of the first set of conditions can be unified, as shown in the following equation 149.

$$\{ \begin{matrix}{p}_{3} ( n ) ⊗ {e}_{21} ( n ) + {p}_{2} ( n ) ⊗ {e}_{22} ( n ) = δ ( n ) \\ {p}_{1} ( n ) ⊗ {e}_{21} ( n ) + {p}_{4} ( n ) ⊗ {e}_{22} ( n ) = 0 \end{matrix} \qquad equation 149$$

Then, the equation 149 could be expressed as a matrix form as equation 150.

$$\{ \begin{matrix}{\underline{E}}_{21} {\underline{p}}_{3} + {\underline{E}}_{22} {\underline{p}}_{2} = \underline{e} \\ {\underline{E}}_{21} {\underline{p}}_{1} + {\underline{E}}_{22} {\underline{p}}_{4} = \underline{0}\end{matrix} \qquad equation 150$$

In the third set of conditions, only the TX2 transmit signal with crosstalk through the transmitting end and only RX1 would receive signal before receiving the crosstalk of the receive end (TX1=0, TX2=QPSK, RX1=1, RX2=0). After the crosstalk response of the TX1 and TX2 transmitters, the RF signal r₁(n) and the RF signal r₂(n) are transmitted only to have the signal U₂(n) from TX2. Therefore, the part of the signal U₂(n) could be obtained from the equations 123 and 124, which could be expressed as equations 151 and 152.

TX₁: r₁(n)=c₂₁(n)⊗u₂(n) equation 151

TX₂: r₂(n)=c₂₂(n)⊗u₂(n) equation 152

Then, when entering the crosstalk response at the receiving end, and after equations 151 and 152 are substituted into equation 125, the signal v_{p,1}(n) could obtained; then the convolution between c₂₁(n) and d₁₁(n) is renamed as the new crosstalk variable, and the convolution is performed. The signal v_{p,1}(n) could as expressed as equation 153.

$$\begin{matrix}{v}_{p , 1} ( n ) = & \{ {u}_{2} ( n ) ⊗ {c}_{21} ( n ) \} ⊗ {d}_{11} ( n ) + \\ & \{ {u}_{2} ( n ) ⊗ {c}_{22} ( n ) \} ⊗ {d}_{21} ( n ) \\ = & {u}_{2} ( n ) ⊗ {f}_{11} ( n ) + {u}_{2} ( n ) ⊗ {f}_{21} ( n )\end{matrix} \qquad equation 153$$

However, in the third set of conditions, only the signal r₁(n) is input through the switch before the crosstalk at the receiving end, so that the signal V_{p,1}(n) of the RX1 only contains the RF signal r₁(n), as expressed in equation 154.

$$\begin{matrix}{v}_{p , 1} ( n ) = \{ {u}_{2} ( n ) ⊗ {c}_{21} ( n ) \} ⊗ {d}_{11} ( n ) \\ = {u}_{2} ( n ) ⊗ {f}_{11} ( n )\end{matrix} \qquad equation 154$$

At the same time, after entering the crosstalk response of the receiving end, the equations 151 is substituted into equation 126 to obtain the signal V_{p,2}(n). The convolution between c₂₁(n) and d₂₁(n) is renamed to the new crosstalk variable f₁₂(n), and convolution between c₂₂(n) and d₂₂(n) is renamed to the new crosstalk variable f₂₂(n). The convolution is renamed to a new crosstalk variable as equation 155.

$$\begin{matrix}{v}_{p , 2} ( n ) = & \{ {u}_{2} ( n ) ⊗ {c}_{21} ( n ) \} ⊗ {d}_{12} ( n ) + \\ & \{ {u}_{2} ( n ) ⊗ {c}_{22} ( n ) \} ⊗ {d}_{22} ( n ) \\ = & {u}_{2} ( n ) ⊗ {f}_{12} ( n ) + {u}_{2} ( n ) ⊗ {f}_{22} ( n )\end{matrix} \qquad equation 155$$

According to the third set of conditions, only the signal is r₁(n) input through the switch before the crosstalk at the receiving end, and the V_{p,2}(n) of the RX2 signal only contains the crosstalk RF signal r₁(n), such as equation 156.

$$\begin{matrix}{v}_{p , 2} ( n ) = \{ {u}_{2} ( n ) ⊗ {c}_{21} ( n ) \} ⊗ {d}_{12} ( n ) \\ = {u}_{2} ( n ) ⊗ {f}_{12} ( n )\end{matrix} \qquad equation 156$$

Subsequently, after entering the digital terminal, it is assumed that the post-processing parameters P₁(n) P₂(n) P₃(n) P₄(n) can counter the signal V_{p,1}(n) of the crosstalk response of RX1 and the V_{p,2}(n) of crosstalk response of RX2, so the equations 154 and 156 are substituted into 127 to obtain received signal z₁(n) at RX1 as shown in equation 157.

$${z}_{1} ( n ) = {p}_{3} ( n ) ⊗ \{ {u}_{2} ( n ) ⊗ {f}_{11} ( n ) \} + {p}_{2} ( n ) ⊗ \{ {u}_{2} ( n ) ⊗ {f}_{12} ( n ) \} \qquad equation 157$$

It is also possible to rearrange equation 157 for z₁(n) of the RX1 corresponding to U₂(n) of the transmit signal at TX2, and then the processing vector suppresses the receive crosstalk response, as shown in equation 158.

$${z}_{1} ( n ) = {u}_{2} ( n ) ⊗ \{ {p}_{3} ( n ) ⊗ {f}_{11} ( n ) \} + {u}_{2} ( n ) ⊗ \{ {p}_{2} ( n ) ⊗ {f}_{12} ( n ) \} \qquad equation 158$$

Substituting equations 154 and 156 into equation 128, Z₂(n) at RX2 could be obtained and expressed as equation 159.

$${z}_{2} ( n ) = {p}_{1} ( n ) ⊗ \{ {u}_{2} ( n ) ⊗ {f}_{11} ( n ) \} + {p}_{4} ( n ) ⊗ \{ {u}_{2} ( n ) ⊗ {f}_{12} ( n ) \} \qquad equation 159$$

The equation 159 can be rearranged to Z₂(n) of RX2 corresponding to u₂(n) of the TX2 transmit signal, and then the processing vector suppresses the received crosstalk response equation, as shown in the equation 160.

$${z}_{2} ( n ) = {u}_{2} ( n ) ⊗ \{ {p}_{1} ( n ) ⊗ {f}_{11} ( n ) \} + {u}_{2} ( n ) ⊗ \{ {p}_{4} ( n ) ⊗ {f}_{12} ( n ) \} \qquad equation 160$$

Finally, in the third set of conditions, the TX2 transmits u₂(n) signal which is the main signal. According to the above equations 158) and 160, it can be seen that the RX1 receive signal z₁(n) of the equation 158 is suppressed and eliminated (equation and =0). At the same time, the RX2 receiving signal z₂(n) in (4.60) must be maintained to receive the original signal (equal and =1). Therefore, the effective set equation of the first set of conditions can be unified as shown in equation 161.

$$\{ \begin{matrix}{p}_{3} ( n ) ⊗ {f}_{11} ( n ) + {p}_{2} ( n ) ⊗ {f}_{12} ( n ) = 0 \\ {p}_{1} ( n ) ⊗ {f}_{11} ( n ) + {p}_{4} ( n ) ⊗ {f}_{12} ( n ) = δ ( n )\end{matrix} \qquad equation 161$$

Then, the equation 161 could expressed in a matrix form as equation 162.

$$\{ \begin{matrix}{\underline{F}}_{11} {\underline{p}}_{3} + {\underline{F}}_{12} {\underline{p}}_{2} = \underline{0} \\ {\underline{F}}_{11} {\underline{p}}_{1} + {\underline{F}}_{12} {\underline{p}}_{4} = \underline{e}\end{matrix} \qquad equation 162$$

In the fourth set of conditions, only the TX2 transmit signal with crosstalk through the transmit end and only RX2 receives signal before the crosstalk of the receive end (TX1=0, TX2=QPSK, RX1=0, RX2=1). Since the third set of conditions is consistent with the conditions of the fourth set of conditions, only the signal u₂(n) from TX2 exists, so the RF signal r₁(n) and the RF signal r₂(n) transmitted by the analog end crosstalk response of TX1 and TX2 respectively can be expressed as equations 151 and 152.

Then, after entering the analog crosstalk receiving end, the 151 and 152 equations are subdivided into equation 125 and thus based on the fourth set of conditions the v_{p,1}(n) signal could be obtained but only contain the signal u₂(n) of TX2, so according to the above equation 153, the new crosstalk parameters f₁₁(n) and f₂₁(n) could be obtained and as shown in equation 163.

$$\begin{matrix}{v}_{p , 1} ( n ) = & \{ {u}_{2} ( n ) ⊗ {c}_{21} ( n ) \} ⊗ {d}_{11} ( n ) + \\ & \{ {u}_{2} ( n ) ⊗ {c}_{22} ( n ) \} ⊗ {d}_{21} ( n ) \\ = & {u}_{2} ( n ) ⊗ {f}_{11} ( n ) + {u}_{2} ( n ) ⊗ {f}_{21} ( n )\end{matrix} \qquad equation 163$$

However, in the fourth set of conditions, only the signal r₂(n) is input through the switch before the crosstalk at the receiving end, so that the signal r₂(n) of the V_{p,1}(n) signal at RX1 only contains the RF signal, such as shown in equation 164.

$$\begin{matrix}{v}_{p , 1} ( n ) = \{ {u}_{2} ( n ) ⊗ {c}_{22} ( n ) \} ⊗ {d}_{21} ( n ) \\ = {u}_{2} ( n ) ⊗ {f}_{21} ( n )\end{matrix} \qquad equation 164$$

At the same time, after entering the crosstalk response of the receiving end, the equations 151 and 152 are substituted into the equation 126 type to obtain the v_{p,2}(n) signal, and since it only contains the signal u₂(n) of TX2, according to the above equation 155, the new crosstalk parameters could be obtained and as shown in equation 165.

$$\begin{matrix}{v}_{p , 2} ( n ) = & \{ {u}_{2} ( n ) ⊗ {c}_{21} ( n ) \} ⊗ {d}_{12} ( n ) + \\ & \{ {u}_{2} ( n ) ⊗ {c}_{22} ( n ) \} ⊗ {d}_{22} ( n ) \\ = & {u}_{2} ( n ) ⊗ {f}_{12} ( n ) + {u}_{2} ( n ) ⊗ {f}_{22} ( n )\end{matrix} \qquad equation 165$$

According to the fourth set of conditions, only the input signal r₂(n) is transmitted through the switch before the crosstalk at the receiving end, and the V_{p,2}(n) signal at RX2 would only contains the crosstalk RF signal r₂(n), as shown in equation 166.

$$\begin{matrix}{v}_{p , 2} ( n ) = \{ {u}_{2} ( n ) ⊗ {c}_{22} ( n ) \} ⊗ {d}_{22} ( n ) \\ = {u}_{2} ( n ) ⊗ {f}_{22} ( n )\end{matrix} \qquad equation 166$$

Subsequently, after entering the digital terminal, it is assumed that the post-processing parameters P₁(n) P₂(n) P₃(n) P₄(n) can counter the v_{p,1}(n) signal of the crosstalk response of RX1 and v_{p,2}(n) of the crosstalk response of RX2, so the equations 164 and 166 are substituted into equation 127, and z₁(n) at RX1 could be obtained and expressed equation 167.

$${z}_{1} ( n ) = {p}_{3} ( n ) ⊗ \{ {u}_{2} ( n ) ⊗ {f}_{21} ( n ) \} + {p}_{2} ( n ) ⊗ \{ {u}_{2} ( n ) ⊗ {f}_{22} ( n ) \} \qquad equation 167$$

The equation 145 could be rearranged into z₁(n) at RX1 corresponding to u₂(n) of TX2, and then the processing vector suppresses the received crosstalk response, as shown in the following equation 168.

$${z}_{1} ( n ) = {u}_{2} ( n ) ⊗ \{ {p}_{3} ( n ) ⊗ {f}_{21} ( n ) \} + {u}_{2} ( n ) ⊗ \{ {p}_{2} ( n ) ⊗ {f}_{22} ( n ) \} \qquad equation 168$$

Substituting equation 164 and 166 into equation 128, at RX2 the receiving signal z₂(n) could be obtained as expressed as equation 169.

$${z}_{2} ( n ) = {p}_{1} ( n ) ⊗ \{ {u}_{2} ( n ) ⊗ {f}_{21} ( n ) \} + {p}_{4} ( n ) ⊗ \{ {u}_{2} ( n ) ⊗ {f}_{22} ( n ) \} \qquad equation 169$$

The equation 169 could be rearranged into z₂(n) of RX2 corresponding to u₂(n) of TX2, and then the processing vector suppresses the received crosstalk response, as shown in the following equation 170.

$${z}_{2} ( n ) = {u}_{2} ( n ) ⊗ \{ {p}_{1} ( n ) ⊗ {f}_{21} ( n ) \} + {u}_{2} ( n ) ⊗ \{ {p}_{4} ( n ⊗ {f}_{22} ( n ) \} \qquad equation 170$$

Finally, in the fourth set of conditions, the TX2 transmits u₂(n) signal which is the main signal. According to the above equations 168 and 170, it can be seen that the RX1 receive signal z₁(n) of the 168 equation is suppressed and eliminated (equation and=0). At the same time, the receiving signal z₂(n) of RX2 in equation 170 must be maintained to maintain the original signal (equal and =1). Therefore, the effective set equation of the fourth set of conditions can be unified, as follows (4.71).

$$\{ \begin{matrix}{p}_{3} ( n ) ⊗ {f}_{21} ( n ) + {p}_{2} ( n ) ⊗ {f}_{22} ( n ) = 0 \\ {p}_{1} ( n ) ⊗ {f}_{21} ( n ) + {p}_{4} ( n ) ⊗ {f}_{22} ( n ) = δ ( n )\end{matrix} \qquad equation 171$$

Then, the equation 171 is expressed in a matrix form as equation 172.

$$\{ \begin{matrix}{\underline{F}}_{21} {\underline{p}}_{3} + {\underline{F}}_{22} {\underline{p}}_{2} = \underline{0} \\ {\underline{F}}_{21} {\underline{p}}_{1} + {\underline{F}}_{22} {\underline{p}}_{4} = \underline{e}\end{matrix} \qquad equation 172$$

However, by merging the above four sets of conditional equations, four sets of equations of the post-compensation parameter P₁ P₂ P₃ P₄ and the new crosstalk parameter E and F are obtained, such as the above equations 140, 150, 162, and 1721. Since the TX1/TX2 signals are introduced with crosstalk by the transceiver after the crosstalk of the second group and the third group, respectively, they are received by RX2/RX1, which might make the signal too small during the actual test. When the group condition is combined with conditions of the fourth set of conditions from the equations 140 and 172 to estimate the compensation, the crosstalk response at the receiving end can be eliminated. Therefore, after the matrix of equations 140 and 172 are combined and arranged, the following equations 173 and 174 could be derived as shown.

$$\begin{matrix}[ \begin{matrix}{\underline{E}}_{11} & {\underline{E}}_{12} \\ {\underline{F}}_{21} & {\underline{F}}_{22}\end{matrix} ] [ \begin{matrix}{\underline{p}}_{3} \\ {\underline{p}}_{2}\end{matrix} ] = [ \begin{matrix}\underline{e} \\ \underline{0}\end{matrix} ] & equation 173 \\ [ \begin{matrix}{\underline{E}}_{11} & {\underline{E}}_{12} \\ {\underline{F}}_{21} & {\underline{F}}_{22}\end{matrix} ] [ \begin{matrix}{\underline{p}}_{1} \\ {\underline{p}}_{4}\end{matrix} ] = [ \begin{matrix}\underline{0} \\ \underline{e}\end{matrix} ] & equation 174\end{matrix}$$

Then, since the vectors E and F are obtained by the LS estimation method, the matrix arranged could become a known parameter vector, and then the equations 173 and 174 could be inverted. The compensation vectors P₁ P₂ P₃ P₄ are processed after the receiving end, as shown in the equations 175 and 176.

$$\begin{matrix}[ \begin{matrix}{\underline{p}}_{3} \\ {\underline{p}}_{2}\end{matrix} ] = {( {G}^{H} G )}^{- 1} {G}^{H} [ \begin{matrix}\underline{e} \\ \underline{0}\end{matrix} ] & equation 175 \\ [ \begin{matrix}{\underline{p}}_{1} \\ {\underline{p}}_{4}\end{matrix} ] = {( {G}^{H} G )}^{- 1} {G}^{H} [ \begin{matrix}\underline{0} \\ \underline{e}\end{matrix} ] & equation 176\end{matrix}$$

Where

$$G = [ \begin{matrix}{\underline{E}}_{11} & {\underline{E}}_{12} \\ {\underline{F}}_{21} & {\underline{F}}_{22}\end{matrix} ]$$

The G matrix contains a matrix of vector arrangements as shown in equations 177 and 178.

$$\begin{matrix}{e}_{11} ( n ) = {c}_{11} ( n ) ⊗ {d}_{11} ( n ) \\ {e}_{12} ( n ) = {c}_{11} ( n ) ⊗ {d}_{12} ( n ) & equation 177 \\ {f}_{21} ( n ) = {c}_{22} ( n ) ⊗ {d}_{21} ( n ) \\ {f}_{22} ( n ) = {c}_{22} ( n ) ⊗ {d}_{22} ( n ) & equation 178\end{matrix}$$

Finally, the receiver post-processing compensation vector P₁ P₂ P₃ P₄ could be obtained through the above equations 175 and 176, and then the crosstalk processing vector at the receiving end is completed, and the crosstalk response from other radio terminals is eliminated.

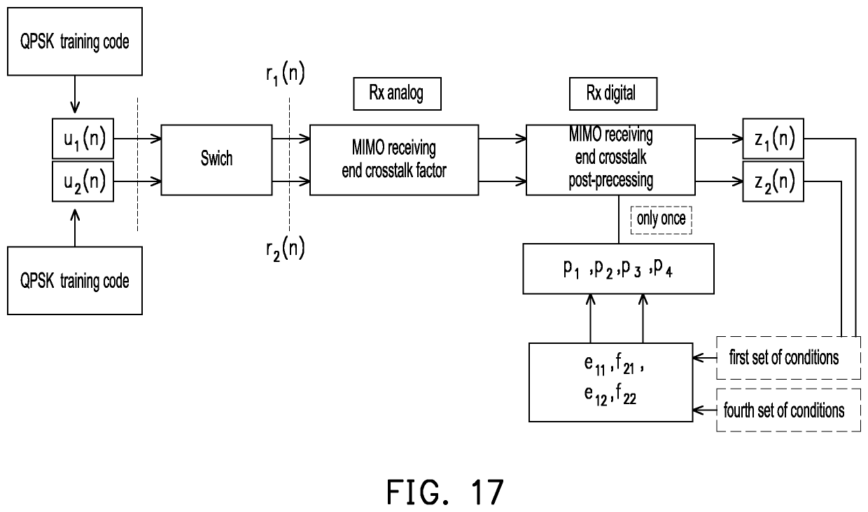

FIG. 17 is a block diagram which shows calculating post-processing parameters of a MIMO receiver according to one of the exemplary embodiments of the disclosure. In this section, the MIMO broadband crosstalk factor estimation and post-processing compensation parameter estimation are proposed according to the above disclosure. A receiver-side crosstalk estimation and compensation system could be prepared for the receiver-side crosstalk adjustment. The overall block diagram is shown in FIG. 17, and according to the following receiving end calibration procedure, under the condition of the same frequency at the same time, the crosstalk response adjustment unknown to the receiving end could be completed.

The detail of FIG. 17 is as follows. First, the method of isolating the transmitting end and switching the receiving end signal by the (LS) method could be used to simultaneously perform the same frequency transmission and reception to complete the estimation. Known QPSK training code could be divided into two reference signals to be transmitted one reference signal at a time through either TX1 or TX2. The switch could be added before receiving the crosstalk at the receiving end. Grounding or connecting signal could be combined to match the signal of RX1 or RX2 to form the above four sets of conditions. However, in the second and third sets of conditions, the TX1/TX2 signal could be received by the RX2/RX1 in sequence after crosstalk has been introduced by the transceiver, which might make the signal energy too small during the actual test. A first set of conditions and a fourth set of conditions form sufficient equations to solve the post-processing parameters P₁ P₂ P₃ P₄, thereby completing the receiver crosstalk response estimation and post-processing compensation.

In the first transmission and reception signal, according to the first group of conditions, the QPSK training signal of u₁(n) is selected to be transmitted by the TX1, and the signal u₂(n) transmitted by the TX2 is null. The signal is then up-converted to the analog crosstalk transmitting end having crosstalk, and then switched by the switcher to receive the r₁(n) signal with crosstalk only before the receiving end. After the r₂(n) signal is grounded, the signal would enter the analog receiving end having crosstalk, and finally the receiving signal is brought into the digital receiving end.

Then, in the second transmission and reception signal, according to the fourth set of conditions, the signal u₁(n) selected to be null in TX1 is transmitted and the QPSK signal u₂(n) is simultaneously transmitted in TX2, and then up-converted into the analog transmitting end with crosstalk. Then, after switching through the switcher, only the receiving signal r₂(n) is input before the crosstalk of the receiving end, and the r₁(n) signal is grounded and then enters the analog crosstalk receiving end, and finally the receiving signal is brought into the digital receiving end. According to the above disclosure, the receiver crosstalk estimation and post-processing compensation are performed, and the received signal Z₁(n) and Z₂(n) for the second transmission and reception are obtained.

After the above two signals are transmitted and received, according to the mathematical model as previously described, the crosstalk responses E₁₁ and E₁₂ of the receiver can be estimated from the first transmission and reception, and the crosstalk responses F₂₁ and F₂₂ are estimated from the second transmission and reception. According to the crosstalk response parameters E₁₁ E₁₂ and F₂₁ F₂₂ estimated above, after the matrix is arranged, such as equations 173) and 174, the inverse matrix could calculated as equations 175 and 176 to obtain post-processing compensation parameters P₁ P₂ P₃ P₄.

However, in order to verify whether the post-processing compensation parameters P₁ P₂ P₃ P₄ can successfully eliminate the crosstalk at the receiving end, it is necessary to assume that the transmitting end is in an ideal state so as to observe the performance of the single-carrier and multi-carrier waiting signal after post-processing compensation. FIG. 18 is a conceptual diagram for testing a MIMO receiver by using a MIMO ideal transmitter according to one of the exemplary embodiments of the disclosure. For architecture as shown in FIG. 18, the u₁(n) and u₂(n) signals are transmitted at the same time. After frequency up-conversion, the z₁(n) and Z₂(n) signals are directly received into the receiving end having crosstalk interference, and then a measurement would be performed to confirm whether z₁(n) successfully cancels the crosstalk signal of r2(n) from RX2 and thus satisfies the equation of 140, and whether z₂(n) successfully cancels the crosstalk signal of R₁(n) from RX1 and thus satisfies the equation of 172.

FIG. 19 is a flow chart which shows a procedure of reducing crosstalk of a MIMO receiver according to one of the exemplary embodiments of the disclosure. In step S1901, TX1 would transmit a QPSK training code while TX2 would transmit a null signal (i.e. no signal). In step S1903, the transmission is assumed to be received by an ideal transmitter. In step S1905, RX1 would receive the QPSK training code from TX1 while RX2 is grounded. In step S1907, the crosstalk parameters E₁₁, E₁₂ would be estimated based on the measurement. In step S1902, TX2 would transmit a QPSK training code while TX1 would transmit a null signal (i.e. no signal). In step S1904, the transmission is assumed to be received by an ideal transmitter. In step S1906, RX2 would receive the QPSK training code from TX2 while RX1 is grounded. In step S1908, the crosstalk parameters F₂₁, E₂₂ would be estimated based on the measurement. In step S1909, the post-processing compensation parameters P₁ P₂ P₃ \sqrt{P}₄ are calculated based on the crosstalk parameters from step S1907 and step S1908.

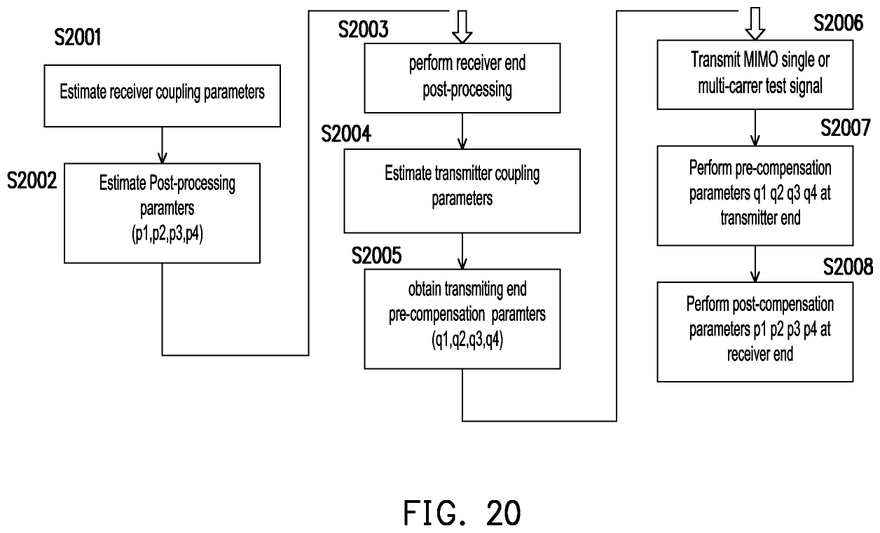

The exemplary embodiments of FIG. 20˜26 and their corresponding written descriptions integrate the previous exemplary embodiments of the MIMO transmitter and MIMO receiver. In general, the receiver would first be configured for reducing crosstalk and then the transmitter will also be configured after the receiver has its crosstalk reduced. The method would involve estimating the broadband crosstalk response and post-processing compensation parameter estimation at the receiving end using the LS technique combined with a separation estimation method. The configuring principle is coherent with previously describe technique of obtaining the crosstalk pre-compensation parameters and post-processing parameters.

FIG. 20 is a flow chart which shows steps of performing a crosstalk estimation and compensation procedure for a MIMO transceiver system according to one of the exemplary embodiments of the disclosure. In step S2001, a SISO based measurement would be performed to estimate coupling parameters of the receiver. The SISO based measurement describe above refers to the fact that when the split estimation method is completed by using the switch, the signal transmission at this time is similar to a single channel SISO system. In step S2002, the post-processing parameters P₁ P₂ P₃ P₄ would be estimated based on the measurement of step S2001.

In step S2003, a post-compensation procedure would be performed at the receiving end based on the post-processing parameters P₁ P₂ P₃ P₄ so as to reduce crosstalk at the receiving end. In step S2004, a MIMO based measurement would be performed to estimate coupling parameters of the transmitter by measuring each permutation of the paths among TX1/TX2 and RX1/RX2. In step S2005, the transmitting end pre-processing compensation parameters could be estimated based on the measurement of step S2004. In step S2006, the transmitter would transmit a MIMO single carrier signal or a MIMO multi-carrier signal. In step S2007, the transmitter would calculate and obtain crosstalk compensation parameters q₁ q₂ q₃ q₄. In steps S2008, the receiver would calculate and obtain the post-processing parameters P₁ P₂ P₃ P₄.

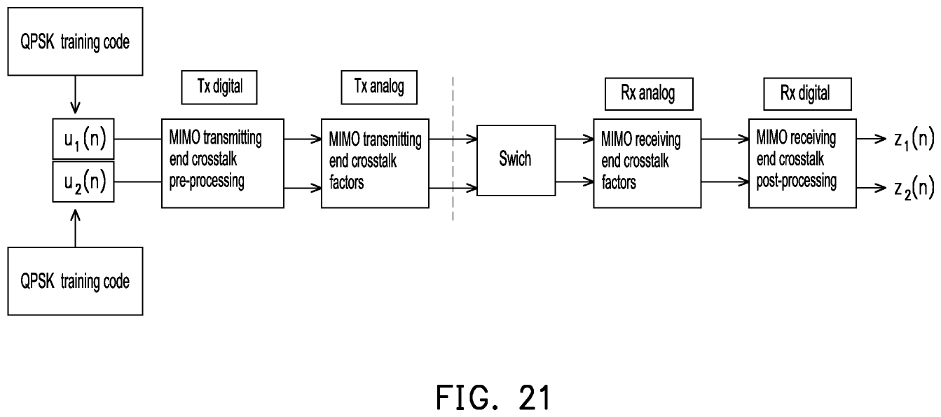

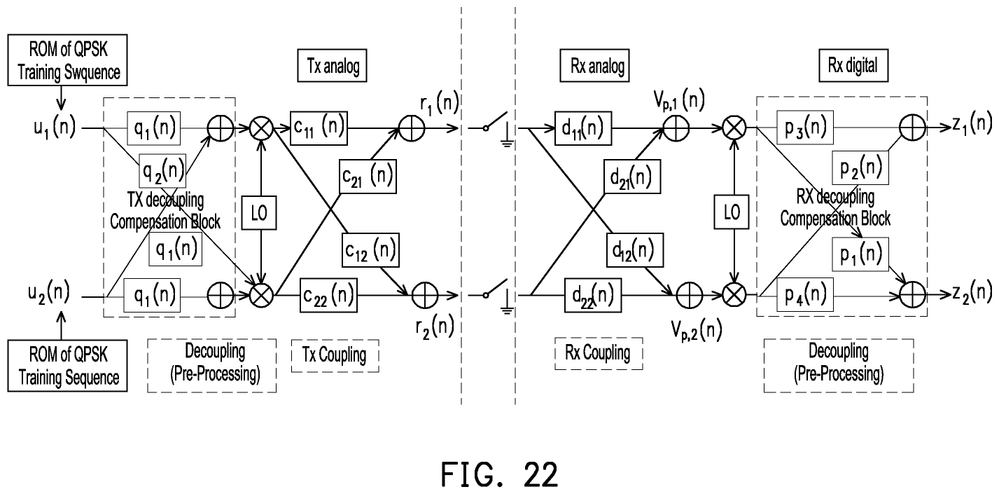

FIG. 21 is a system block diagram of a MIMO transceiver system according to one of the exemplary embodiments of the disclosure. The method of configuring the integrated system transceiver system is based on a combination of configuring a transmitter and a receiver, and the techniques of which are not repeated. Transceiver of FIG. 21 would first need to complete the estimation of the crosstalk response of the receiving end according to method of configuring the receiver previously described in order to suppress the crosstalk of the receiving end through the obtained post processing parameters, so that the receiving end would no longer suffer crosstalk problem. Assuming that a crosstalk problem remains, the crosstalk response estimation of the transmitter can be completed by using the method of configuring the transmitter as previously described. Consequently, the receiver post-processing parameters and the transmitter pre-compensation parameters may both be used to configure the transceiver. Overall, the system architecture of a MIMO transceiver system which utilizes the disclosed method according to one of the exemplary embodiments of the disclosure is shown in FIG. 22.

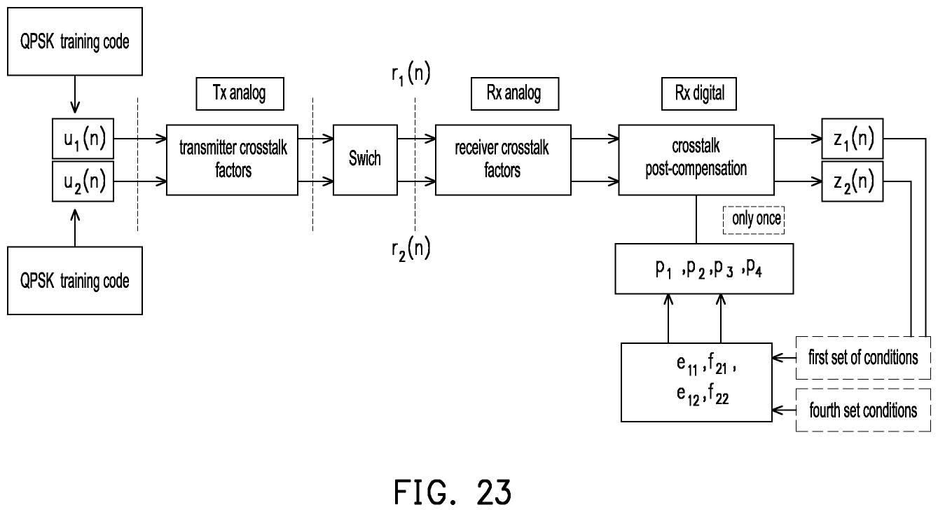

FIG. 23 shows a block diagram of a process of reducing crosstalk at the receiving end of a MIMO transceiver system according to one of the exemplary embodiments of the disclosure. Thus, in the estimation of the receiving end of the transceiver, the crosstalk parameter E₁₁, E₁₂ and F₂₁, F₂₂ of the receiving end could be obtained by using the QPSK training code to complete the estimation method according to the first set conditions and the fourth set conditions as previously described. The crosstalk parameters could then be used to derive the post-processing parameter P₁ P₂ P₃ P₄ which would be transmitted to the receiver only once for performing pro-processing crosstalk compensation procedure to eliminate or reduce the crosstalk. In order to confirm that the post-processing parameters would be able to successfully eliminate the crosstalk at the receiving end, it could be necessary to maintain the single-carrier and the post-processing compensated single carrier under the conditions of the first set conditions and the fourth set conditions respectively.

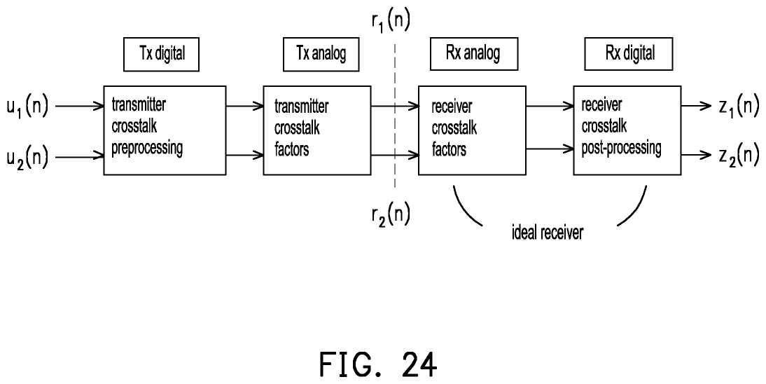

FIG. 24 is a block of the MIMO transceiver system after processing through the receiving end according to one of the exemplary embodiments of the disclosure. As previously described, after the post-processing compensation parameters of the receiver has been calculated, the processing compensation parameters could then be applied in the receiver to complete the method of configuring the receiver. After the receiver has been configured, the receiver could be thought of as an ideal receiver to configure the transmitter in order to further reduce the crosstalk problem. To reduce predict the cross-talk response of the transmitter, the previously described method of configuring a MIMO transmitter could be applied.

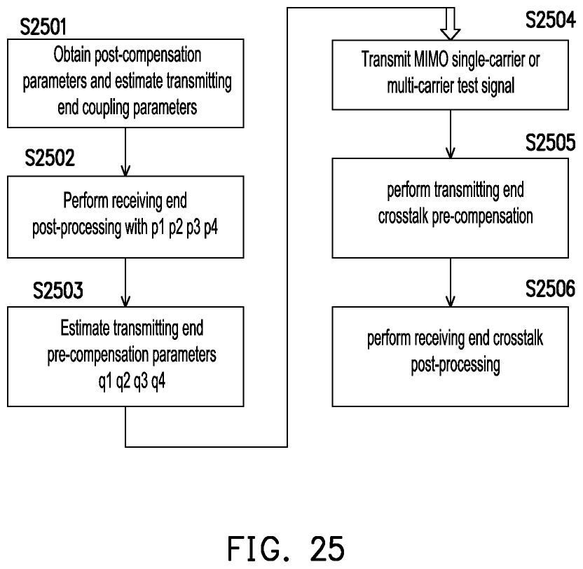

For FIG. 24, the receiving end after the post-processing compensation of the receiving end can be regarded as consistent with the previously described scenario for reducing the crosstalk of the transmitting end. As the receiving end is understood as the ideal state, and then the whole system could be transmitted and received according to the system architecture. Next, the transmitter could be calibrated to estimate the crosstalk by using the calculated pre-compensation parameters. The procedure is shown in FIG. 25 which is a flow chart showing steps of combining crosstalk reducing procedures at the transmitting end and the receiving end according to one of the exemplary embodiments of the disclosure. Since each of the steps has been previously described, a repetition of the written description would not be necessary.

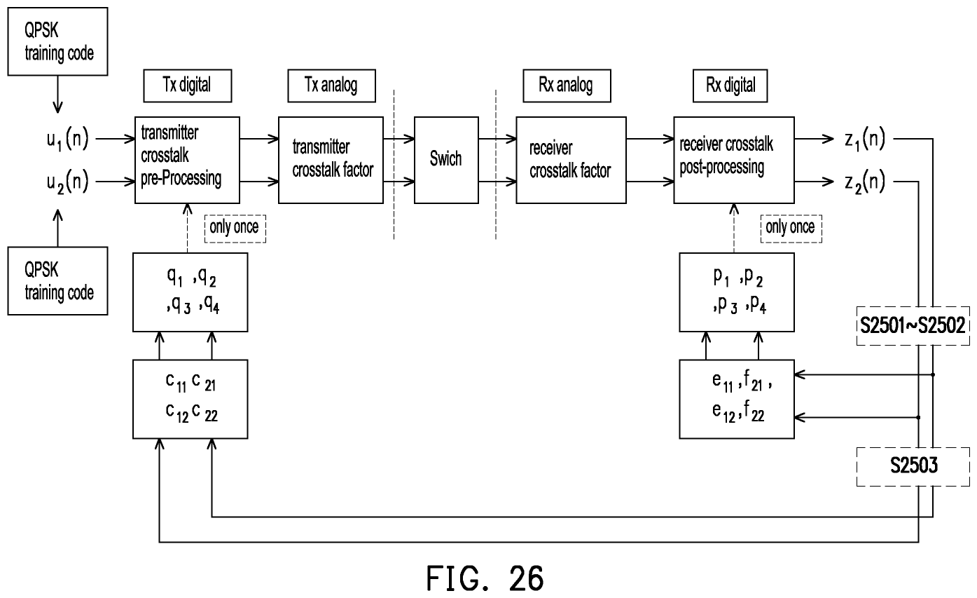

FIG. 26 is a block diagram which shows using information from the receiving end to perform crosstalk reducing procedures at the transmitting end and the receiving end according to one of the exemplary embodiments of the disclosure. The post-processing parameters P₁ P₂ P₃ P₄ of the receiving end and the pre-compensation parameters q₁ q₂ q₃ q₄ of the transmitting end could be estimated by using steps S2501˜S2503 and also steps S2504˜S2506. After the post-processing parameters P₁ P₂ P₃ P₄ and the pre-compensation parameters q₁ q₂ q₃ q₄ are procured, those parameters would be delivered to the receiver and the transmitter only once respectively.

In view of the aforementioned descriptions, the disclosure is suitable for being used in a wireless communication system and is able to reduce the crosstalk of a MIMO transmitter, to reduce the crosstalk of a MIMO receiver, or to reduce the crosstalk of a MIMO transmitter and receiver.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method of configuring a multi-input multi-output (MIMO) wideband receiver comprising:
estimating, on a single-input and single-out (SISO) basis, a set of post-processing parameters for a plurality of receiver channels;
receiving, by each of the plurality of receiver channels, a first test signal which is transmitted from a first transmitter channel on a MIMO basis;
calculating a first set of crosstalk parameters in response to receiving the first test signal;
receiving, by each of the plurality of receiver channels, a second test signal which is transmitted from a second transmitter channel on the MIMO basis;
calculating a second set of crosstalk parameters in response to receiving second test signal; and
calculating the set of post-processing parameters based on the first set of crosstalk parameters and the second set of crosstalk parameters by cancelling a crosstalk interference among plurality of receiver channels.

2. The method of claim 1, wherein estimating, on the SISO basis, the set of post-processing parameters for the plurality of receiver channels comprising:
estimating a second post-processing parameter and a third post-processing parameter only between the first transmitter channel and the first receiver channel;
switching from between the first transmitter channel and the first receiver channel to between the second transmitter channel and the second receiver channel; and
estimating a first post-processing parameter and a fourth post-processing parameter only between the first transmitter channel and the first receiver channel, wherein the set of post-processing parameters comprising the first post-processing parameter, the second post-processing parameter, the third post-processing parameter, and the fourth post-processing parameter.

3. The method of claim 1, wherein receiving, by each of the plurality of receiver channels, the first test signal which is transmitted from the first transmitter channel on the MIMO basis comprising:
receiving, by a first receiver channel of the plurality of receiver channels, the first test signal which is transmitted from the first transmitter channel on the MIMO basis while not receiving from the second transmitter channel;
grounding the second receiver channel;
receiving, by a second receiver channel of the plurality of receiver channels, the first test signal which is transmitted from the first transmitter channel on the MIMO basis while not receiving from the first transmitter channel; and
grounding the first receiver channel.

4. The method of claim 3, wherein calculating the first set of crosstalk parameters in response to receiving the first test signal comprising:
obtaining a first crosstalk parameter and a second crosstalk parameter based on the first test signal received by the first receiver channel; and
obtaining a third crosstalk parameter and a fourth crosstalk parameter based on the first test signal received by the second receiver channel, wherein the first set of crosstalk parameters comprising the first crosstalk parameter, the second crosstalk parameter, the third crosstalk parameter, and the fourth crosstalk parameter.

5. The method of claim 1, wherein receiving, by each of the plurality of receiver channels, the second test signal which is transmitted from the second transmitter channel on the MIMO basis comprising:
receiving, by a first receiver channel of the plurality of receiver channels, the second test signal which is transmitted from the second transmitter channel on the MIMO basis while not receiving from the first transmitter channel;
grounding the second receiver channel;
receiving, by a second receiver channel of the plurality of receiver channels, the second test signal which is transmitted from the second transmitter channel on the MIMO basis while not receiving from the first transmitter channel; and
grounding the first receiver channel.

6. The method of claim 5, wherein calculating the second set of crosstalk parameters in response to receiving the second test signal comprising:
obtaining a fifth crosstalk parameter and a sixth crosstalk parameter based on the second test signal received by the first receiver channel; and
obtaining a seventh crosstalk parameter and an eighth crosstalk parameter based on the second test signal received by the second receiver channel, wherein the second set of crosstalk parameters comprising the fifth crosstalk parameter, the sixth crosstalk parameter, the seventh crosstalk parameter, and the eighth crosstalk parameter.

7. The method of claim 5, wherein calculating the set of post-processing parameters based on the first set of crosstalk parameters further comprising:
estimating the first crosstalk parameter and the second crosstalk parameter based on a least square technique.

8. The method of claim 6, wherein calculating the set of post-processing parameters based on the second set of crosstalk parameters further comprising:
estimating the fifth crosstalk parameter and the sixth crosstalk parameter based on a least square technique.

9. The method of claim 1, further comprising:
determining whether the set of post-processing parameters cancel out crosstalk among the plurality of receiver channels.

10. The method of claim 1, wherein the first test signal and the second test signal are different quadrature phase shift keying (QPSK) training sequences.

11. A method of configuring a multi-input multi-output (MIMO) wideband transmitter comprising:
transmitting on a MIMO basis, through a first transmitter channel of a plurality of transmitting channels, a first test signal to be received by a first receiver channel; transmitting on the MIMO basis, through a second transmitter channel of the plurality of transmitting channels, a second test signal to be received by a second receiver channel;
determining, a first received signal received by the first receiver channel and determining a second received signal received by the second receiver channel;
estimating, a set of coupling parameters for the plurality of transmitter channels based on the first received signal and the second received signal; and
calculating, based on the set of coupling parameters, a set of pre-processing compensation parameters by cancelling a crosstalk interference among the plurality of transmitter channels.

12. The method of claim 11, wherein transmitting by the first transmitter channel the first test signal to be received by the first receiver channel and transmitting by the second transmitter channel the second test signal to be received by the second receiver channel occur simultaneously.

13. The method of claim 11, wherein the first test signal and the second test signal are different quadrature phase shift keying (QPSK) training sequences.

14. The method of claim 11, wherein estimating the set of coupling parameters is based on a least square technique.

15. The method of claim 14, wherein estimating the set of coupling parameters comprising:
determining the first received signal and the first received signal by setting the set of pre-processing compensation parameters to zero.

16. The method of claim 11, further comprising:
determining whether the transmitter has cancelled the crosstalk interference among the plurality of transmitter channels by applying the pre-processing compensation parameters to a processor of the transmitter.

17. The method of claim 14, wherein estimating the set of coupling parameters further comprising: assuming the first receiver channel and the second receiver channel as an ideal receiver.

18. The method of claim 16, wherein the pre-processing compensation parameters are applied to the processor of the transmitter only once.

19. A multi-input multi-output (MIMO) wideband receiver comprising:
a wireless receiver comprising a plurality of receiver channels comprising a first receiver channel and a second receiver channel; and
a processor coupled to the wireless receiver and configured to:
estimate, on a single-input and single-out (SISO) basis, a set of post-processing parameters for the plurality of receiver channels;
receive, by each of the plurality of receiver channels, a first test signal which is transmitted from a first transmitter channel on a MIMO basis;
calculate a first set of crosstalk parameters in response to receiving the first test signal;
receive, by each of the plurality of receiver channels, a second test signal which is transmitted from a second transmitter channel on the MIMO basis;
calculate a second set of crosstalk parameters in response to receiving second test signal; and
calculate a set of post-processing parameters based on the first set of crosstalk parameters and the second set of crosstalk parameters by cancelling a crosstalk interference among the plurality of receiver channels.

20. A multi-input multi-output (MIMO) wideband transmitter comprising:
a wireless transmitter comprising a plurality of transmitter channels comprising a first transmitter channel and a second transmitter channel; and
a processor coupled to the wireless transmitter and configured to:
transmit on the MIMO basis, through the first transmitter channel, a first test signal to be received by a first receiver channel and simultaneously transmitting, through the second transmitter channel, a second test signal to be received by a second receiver channel;
determine, a first received signal received by the first receiver channel and determining a second received signal received by the second receiver channel;
estimate, a set of coupling parameters for the plurality of transmitter channels based on the first received signal and the second received signal; and
calculate, based on the set of coupling parameters, a set of pre-processing compensation parameters by cancelling a crosstalk interference among the plurality of transmitter channels.
